(19) United States
(12) Patent Application Publication
(10) Pub. No.: US 2002/0028857 A1
(43) Pub. Date: Mar. 7, 2002

(54) Compostable, degradable plastic compositions and articles thereof

(76) Inventor: Norman L. Holy, Yardley, PA (US)

Correspondence Address: BIRCH STEWART KOLASCH & BIRCH, PO BOX 747, FALLS CHURCH, VA, 22040-0747, US

(21) Appl. No.: 09/820,916

(22) Filed: Mar. 30, 2001

Related U.S. Application Data
(60) Provisional application No. 60/193,449, filed on Mar. 31, 2000.

(51) Int. Cl. C08K 3/00; C08K 5/00; C08K 11/00

(52) U.S. Cl. 523/124; 523/128

(57) ABSTRACT

The present invention relates to thermoplastic compositions which are degradable and/or compostable, the method of preparation of the degradable and/or compostable compositions and use of the degradable and/or compostable compositions in a monofilament, shaped article or film, or may be used as a coating, e.g., of paper, to achieve a stronger article. These compositions have the advantage over existing biodegradable and compostable compositions by exhibiting a higher dimensional stability and comparatively low cost.

### TECHNICAL FIELD

The present invention relates to thermoplastic compositions which are degradable and/or compostable, the method of preparation of the degradable and/or compostable compositions and use of the degradable and/or compostable compositions in a monofilament, shell of a (micro)sphere, shaped article or film, or may be used as a coating, e.g., of paper, to achieve a stronger article. These compositions have the advantage over existing biodegradable and compostable compositions by exhibiting a higher dimensional stability and comparatively low cost.

The present invention relates to polymeric compositions that are compostable and/or biodegradable and that can be melt processed into various forms, including injection molded or blow molded pieces, films, monofilaments, fibers, and nonwovens. These products have substantial physical and thermomechanical integrity. Injection molded articles include disposable fast food utensils, syringes, pens, and disposable razors. Blow molded articles include bottles and containers. The polymeric compositions may be formed as a film. Films may be either blown or cast and are suitable for use as agricultural mulch, sacks, or grocery bags, garbage bags, both food and nonfood packaging, or as backsheets in articles such as diapers, sanitary napkins, pantiliners, and the like, which are adapted for absorbing various bodily fluids. Paper may be coated with compositions of the present invention. Monofilament or multifilament from such polymer compositions may be converted into matting for erosion control or crop protection. Monofilaments may also be converted to degradable fishing line or degradable fishing net.

The compostable and/or biodegradable polymeric composition of the present invention can be formed into hollow/filled plastic microspheres or small spheres for use as a coating for paper, a filler in plastics, toiletries, skin treatments, creams, lotions, fragrances, and foundation creams, diagnostic image processing, coating resins, a coating to improve paper printability and/or strength without the use of solvent, especially wet strength, a substitute for TiO₂ in paints, a uniform encapsulant for liquid crystal polymers, in plastic foam compositions and in concrete and asphalt compositions. Large spheres can be used as “packing chips” or insulation for attics or walls of home or commercial construction.

The present invention also enables a method by which the polymer in hollow microspheres or spheres may be oriented isotropically. Having isotropically oriented polymer in the shell represents an increase in the crush strength, permitting very thin shells and very low cost/volume packing chips and insulation. The polymer is not limited to biodegradable materials but may be of any thermoplastic.

### BACKGROUND OF THE INVENTION

The term “biodegradable” is not well-defined in the art. While some thermoplastic materials which merely disassemble or disintegrate into smaller thermoplastic pieces over time have been termed “biodegradable”. A “biodegradeable” material is defined herein as capable of mineralizing essentially to completion over time, leaving almost no synthetic, hazardous or toxic residue. The amount of time varies, as exemplified by natural materials. Some natural materials, such as grass or flesh, biodegrade or are consumed in a matter of days or weeks, while other natural materials, such as trees or bone, may take years to disappear completely.

A “compostable” material breaks down to humus, with mineralization initiated during the composting process, at a rate appropriate for the process requirements of the composting center, leaving no synthetic, hazardous or toxic residue. The term “mineralization” refers to the metabolic conversion of organic compounds to naturally occurring gases, biomass and inorganic constituents.

Over the course of the last thirty years there have been many patents in the area of biodegradable plastics; the number now exceeds 500. Yet none of these patents has led to products which have been successful in establishing appreciable markets in the overall plastics market. The prior art has failed primarily in one or more of four areas: 1) the articles lacked sufficient strength, 2) the articles had poor shelf life, 3) the articles were too expensive, and/or 4) fabrication into a useful article was difficult. The area where failure occurred most often was in price, e.g., polyhydroxybutyrates (e.g., Biopol) have been patented extensively, but products from this polymer cost as much as 5-20 times as much as non-biodegradable products competing in the same markets. Another area with high patenting activity has been starch-based products. One failing of these products is in the strength category: starch-based plastics are often too weak and too brittle to be attractive. Another failing of starch-based products is they lose strength under typical storage conditions through absorption of moisture which leads to a weakening of the plastic.

In some circumstances it would be desirable to have degradable materials which would never be collected for either composting or recycling. When construction occurs along highways, there often needs to be an effort to control erosion of the landscape while plant life, such as grass, trees or flowers, is established. Significant erosion is unsightly and even costly. To hold the soil in place, mats or straw are used. Mats may be constructed of natural fibers such as jute or hemp, or cotton, or be made of synthetic polymers such as polypropylene or polyethylene. The product of natural fibers are often expensive and heavy, while the plastics are not biodegradable. Polypropylene does break down gradually through a photochemical process, but as the plant life flourishes, the suns rays are blocked, thereby resulting in fragments remaining in the environment for several years. What is needed is a mat in which the webbing first expands or swells, presenting a bigger barrier to water and soil movement, then fragmenting and finally biodegrading.

A similar application is in the seeding of grass at a home site. After the site is graded the homeowner does not wish to see the soil washed away while waiting for the grass to become established. Using a matting to hold the soil while the grass is becoming established makes sense, and ideally, the homeowner would not like to be required to remove the mat after the grass has grown. Leaving a mat of polyethylene or polypropylene on the lawn as unsightly and risks the mat becoming caught in the cutting blades of the lawnmower.

Yet another use for a matting which degrades during its intended application is in protecting fruit trees while the fruit is ripening. One example is for cherry trees, where birds will strip the tree of fruit just as it ripens, thereby reducing the harvest. Netting is often placed over the trees to protect the fruit, but these nets, often of polypropylene, do not degrade, and must be removed from the tree, causing damage to the branches and leaves, as well as being an expensive operation. What would be attractive to the growers is a netting which could be placed on the tree, protecting the crop during the fruiting season, yet disappearing by the time the trees would need to be trimmed or prepared for the next season.

The present invention, in part, relates to the biodegradable and/or compostable polymeric composition in the form of hollow/filled plastic microspheres or small spheres. A process is described wherein the polymer of the shell of microspheres or small/large spheres is oriented isotropically.

Large plastic spheres are made in the conventional art by injection molding, followed by sealing the halves of the sphere together. The compostable and/or biodegradable polymeric composition of the present invention can be formed into hollow/filled plastic microspheres or small spheres prepared using a higher throughput approach. Large spheres can be made using the “ribbon machine” normally used to make glass objects such as light bulbs or glass Christmas tree ornaments. The ribbon machine in the normal operation does not seal the bulb. When a sealed sphere is desired, the ribbon machine can be modified to allow the opening to be closed and fused. The spheres are then expanded to effect orientation of the polymer in the shell, i.e., the polymer becomes isotropically oriented.

Leonard B. Torobin discloses the generation of hollow plastic microspheres in the following closely related U.S. Pat. Nos. 5,397,759, 5,225,123, 5,212,143, 4,793,980, 4,777,154, 4,743,545, 4,671,909, 4,637,990, 4,582,534, 4,568,389, 4,548,196, 4,548,196, 4,536,361, 4,525,314, 4,415,512, 4,363,646, 4,303,736, 4,303,732, 4,303,731, 4,303,730, 4,303,729, 4,303,603, 4,303,433, 4,303,432, 4,303,431, 4,303,061, all herein incorporated as references. However, there is no teaching of the use of biodegradable thermoplastics by Torobin. While Torobin teaches preparation of microspheres, there is no teaching of preparation or use of spheres larger than 5 microns. While spheres larger than 5 microns are known(e.g., sizes from table tennis balls to beach balls), these are made via injection molding and then sealing the halves of the sphere together.

In general, orientation of the molecules in thermoplastics is important to the strength of the material and therefore very desirable. What is very well established in the patent art is “uniaxial” or “biaxial” orientation. The strength of the thermoplastic in the “machine direction” and “transverse” direction are important numbers that determine the strength of an object. To the best of the present inventor's knowledge, there is no teaching by Torobin, or any other source, of making micro-, small or large spheres with partially or completely isotropically oriented thermoplastics.

The present invention, in part, provides a process and an apparatus for making hollow plastic micro-, small or large spheres.

Also, the present invention, in part, relates to hollow plastic microspheres or small spheres prepared of a polymer that is partially or fully oriented.

The present invention, in part, relates to biodegradable plastic microspheres or small or large spheres wherein the polymer is isotropically partially or fully oriented.

Additionally, the present invention, in part, is drawn to biodegradable plastic microspheres or small or large spheres.

The present invention, in part, is drawn to a step for preparing hollow plastic microspheres or small or large spheres, followed by a step where the (micro)spheres are expanded at a temperature below the melting point of the polymer, but above the glass transition temperature.

The present invention, in part, is drawn to the use of hollow plastic microspheres as filler materials. The present invention, in part, is a process for preparing in an economical, simple manner hollow plastic microspheres or small or large spheres which are substantially spherical in shape, uniform in size, wall thickness, and strength characteristics.

The present invention, in part, is drawn to a process for the preparation of hollow plastic microspheres or small or large spheres or large bulbs with compostable/biodegradable polymers.

The present invention, in part, is drawn to plastic microspheres containing an organic compound or mixture of compounds in the inner cavity of the sphere.

The present invention, in part, is drawn to clear, hollow plastic microspheres containing organic compounds in the inner cavity of the microsphere for liquid crystal or flat panel display.

The present invention, in part, is drawn to the use of the hollow plastic small spheres of the present invention in the manufacture of improved foams.

The present invention, in part, is drawn to the use of the hollow plastic spheres in the manufacture of improved insulation materials for walls or attics or ceilings.

The present invention, in part, is drawn to the use of hollow plastic spheres or bulbs as packing chips.

Additionally there are advantages of forming the compostable/biodegradable polymer into a film, since the degradable film could be used in a variety of situations. Photodegradable polyethylene films are used as mulch in agricultural applications around the world. Starch-filled polyethylene films have also been used in mulch film. The polyethylene in these latter films does not truly biodegrade for many centuries. What is needed is a mulch film, which does not rely entirely upon photochemical degradation and allows other mechanisms, such as hydrolysis, to lead to fragments of sufficiently low molecular weight that natural biodegradation can finish the biodegradation process over the desired time period.

Polymeric materials are also converted into films that are used in very high volumes in many countries of the world. Articles include sacks such as grocery or shopping sacks, and refuse or garbage bags. These items are difficult to collect and recycle, so mostly they are incinerated or go to landfills, where they take up space and do not degrade for decades or even centuries. Attempts to solve this problem have included starch-filled polyethylene garbage bags, but these proved not to be biodegradable and were eventually removed from the marketplace. While in theory the plastic in these bags is recyclable, in practice a significant percentage of the plastic does not get recycled for a variety of reasons. A more sensible fate is for the bags to go to a composting center; however, to date there is no plastic meeting the requirements of low cost, high strength and compostability.

Another practical application of biodegradable polymeric materials is in disposable absorbent articles. Currently, the polymeric materials used in disposable absorbent need to be more readily biodegraded and, preferably, more readily composted. There is a need to replace polyethylene backsheets in absorbent articles with liquid impervious films of biodegradable material, since the backsheet is typically one of the largest non-biodegradable components of a conventional disposable absorbent article.

Packing material is typically a foamed polystyrene that has the ideal strength to weight ratio, yet is not biodegradable. What is needed is a very low density, biodegradable material which has sufficient strength to survive the event of shipping.

An important quality lacking in the biodegradable articles of the prior art is sufficient strength to make the product useful for a variety of applications. The compositions failed to include polymers with enough strength to make a product with acceptable performance characteristics.

The present invention, in part, provides for a spectrum of degradable plastics which will be suitable to almost any application. Ideally, such a polymeric composition can be used to form more readily compostable products. The plastics of the present invention can be formed into films, coatings, fibers, molded articles or thermoformed articles.

The present invention, in part, provides for materials which are relatively low in cost, and have improved storage properties.

### SUMMARY OF THE INVENTION

The present invention includes a compostable, degradable polymer composition, its method of preparation and use comprising:

polymer (A) which is a polyesteramide copolymer;

polymer (B) which is at least one polymer selected from the group consisting of polyethylenevinyl alcohol, polyvinyl alcohol, polyester, starch, starch derivative, cellulose, polyethylene glycol, chitin, amylose, amylopectin, starch derivatized with ethyleneimine, cellulose derivatized with ethyleneimine, polysaccharides derivatized with ethyleneimine, lignin derivatized with ethyleneimine, farinaceous materials derivatized with ethyleneimine and mixtures thereof;

component (C) which is a plasticizer,; and

component (D) which is a crosslinking agent;

wherein the polymer composition comprises 0 to 60 wt % of polymer (B), 0 to 25 wt % of component (C), and 0 to 5 wt % of component (D);

wherein all wt % values are based upon the total weight of the polymer composition; and

with the proviso that the polymer composition must contain at least one of polymer (B) and component (D).

A feature of the present invention is that the polyesteramide copolymer is blended with the polymer containing alcohol moieties, since this polyalcohol provides strength while not adversely affecting the biodegradability and compostability of the polymer composition.

Polymer (A) of the present invention may be prepared from, at least one of the following sets of reactants:

i) cyclic amide, dicarboxylic acid or ester and aliphatic diol;

ii) aliphatic polyamide and a cyclic ester, a diol or both;

iii) aliphatic diamine, dicarboxylic acid or ester and aliphatic diol;

iv) cyclic amide, dicarboxylic acid or ester, tricarboylic acid or ester, and aliphatic diol; and diol;

v) cyclic amide and cyclic ester;

vi) aminocarboxylic acid, dicarboxylic acid or ester and aliphatic diol;

vii) aliphatic diamine and/or triamine, aliphatic diol, dicarboxylic acid or ester and cyclic amide;

viii) aliphatic polyamide and polyester;

ix) polymerized vegetable oil and aliphatic diamine and aliphatic diol;

x) cyclic amide, aminocarboxylic acid, and hydroxycarboxylic acid;

xi) cyclic amide and hydroxycarboxylic acid;

xii) aliphatic polyamide and hydroxycarboxylic acid;

xiii) cyclic amide, cyclic ester, dicarboxylic acid or ester and aliphatic diol;

xiv) a triol/diol/aliphatic dicarboxylic acid crosspolymer and a polyamide; and

xv) triol, diol, aliphatic dicarboxylic acid and a cyclic amide.

The compostable, degradable polymer composition may be in the form of a film, an injection molded article, a monofilament, a fiber and a manufactured article.

Polymer (A) is preferably nylon 6 or nylon 66 modified by incorporating adipic, lactic, caprolactone, ethylene glycol, or 1,4-butanediol units into the polymer backbone, and can be either of block or random copolymer structure.

One advantage of a degradable plastic based upon polymers having amide structures, is improved stability under normal storage conditions. Moisture absorption actually toughens polyamides by serving as a plasticizer.

In the polyesteramide chains, the ester structures provide points along the polymer chain for relatively easy fragmentation to occur. Therefore as fragmentation progresses, the fragments have an ever increasing percent of amide structures. These lower molecular weight fragments having high amide content are more easily biodegraded than high molecular weight polyamides. As the molecular weight of these fragments decreases and approaches 2000 or less, the rate of biodegradation increases. Fragments under 1000 molecular weight degrade much more rapidly than those at 2000 molecular weight.

Fragmentation can also occur in the crosslinking segment, at either the point where the crosslinking agent bonds to the polymers, for example at the ester links (when agents such as tri- or tetracarboxylic acids/esters are employed) or at the salt bridges (when the crosslinking agent is prepared from zinc). The initial object is to generate fragments with molecular weights under the value required for chain entanglement. This will mean the loss of plastic properties.

Polyalcohols such as PVOH, EVOH and starch aid in the degradation process by swelling the polymeric composition which increases the distance between the polymer chains, thereby lowering the barrier for intrusion of water and microorganisms into the interior of the polymeric materials. The use of phosphate nutrients (such as zinc pyrophosphate) encourages microorganism metabolism.

While the copolymers containing amide and ester units have excellent physical properties, an approach of this invention which can tailor the physical properties to a particular end-use is to crosslink the copolymers. The physical properties of the biodegradable/compostable polymeric composition will depend upon the concentration and the type of the crosslinking agent and upon the point in the preparation wherein the crosslinking agents are added. Since the biodegradable/compostable polymeric composition of the present invention is not limited to a particular end-use, the concentration, type and addition step of the crosslinking agents are not particularly limited.

Preparing a polyamide in which ester units occur regularly, as monomer, dimer, trimer, or as blocks, in the polymer yields a material which is susceptible to hydrolytic cleavage. Cleavage at the ester linkages yields fragments of polymer much lower in molecular weight than that of the original chain, and biological processes are much more facile in consuming these chain fragments. The rate of biodegradation increases as the size of the chain fragments decreases and as the ester content increases.

It has been discovered that hydrolysis of the polymer can be catalyzed by altering the pH conditions in the microenvironment of the polymer, adding metal salts, or by the action of microorganisms. The rate of biodegradation of esteramide copolymers increases with increasing ester content, but the rates are generally slower than those for polycaprolactone or polylactic homopolymers. For articles requiring rapid degradation, some approach may be required (for some articles of commerce) to accelerate this process. One approach to increasing the rate of biodegradation is to add materials which are prodegradants: these materials are largely stable to the use conditions, but become active during the degradation or composting phase. One approach is to enhance hydrolysis with protic or metal catalysts. Two particularly effective catalysts for this approach to degrading the polymers discovered during the course of this work are ammonium polyphosphate and zinc pyrophosphate. One or both of these salts may be incorporated at a level of 0.0-10.0%, more preferably between 0.1-5.0%, most preferably 0.5-2.0%. Ammonium polyphosphate is used typically as a fire retardant in plastics, and while this is in itself a useful purpose, what has been discovered here is that it accelerates decomposition of the plastic material especially under composting conditions by affecting the pH of the microenvironment, facilitating hydrolysis, and simultaneously providing nitrogen and phosphate to microorganisms.

Another aspect of the present invention is the use of polymers containing alcohol groups as blending materials to impart certain qualities to the final composition which are not available through the use of polyesteramides alone. A preferred polyalcohol is polyvinyl alcohol(PVOH), which not only provides for thin, exceptionally strong films, but also causes the plastic article to swell in the presence of moisture, thereby allowing for moisture and even microorganisms to achieve intimate contact with the polyesteramide chains. The swelling creates a microenvironment for an acceleration of degradation. PVOH is also attractive because the blends with polyesteramides form very strong, pliable products. The films of PVOH and polyesteramide can be very thin and strong. Other polymers which allow for swelling are polyethylenevinyl alcohol (EVOH), polylactic acid, an oxidized polyketone, polyhydroxyalkanoate, starch, starch derivative, cellulose, polyethylene glycol, chitin, amylose, amylopectin, starch derivatized with ethyleneimine, cellulose derivatized with ethyleneimine, polysaccharides derivatized with ethyleneimine, lignin derivatized with ethyleneimine, farinaceous materials derivatized with ethyleneimine and mixtures thereof. The starch derivative includes destructurized starch.

The compositions of this invention comprise using a polyesteramide alone, or as a blend with one or more polyalcohols to form a uniform, substantially homogeneous blend. In order to achieve a balance of properties, strength, durability in use, shelf life, cost, and degradability, it is preferable to include a variety of synthetic and natural materials. It is expected for the combination of polymers of the present invention to have synergistic effects in which desirable properties are enhanced over the qualities of the components.

The present invention also provides a process for preparing such biodegradable thermoplastic polymer blend compositions, the steps of which comprise: (a) preparing a polyamide with ester linkages therein, polymer (A); and (b) using this copolymer alone or blending this copolymer with one or more polymer(s) polymer (B) to form uniform, substantially homogenous blends. The blending of the polymer components may be accompanied by melting to form a melt-blend. The compositions of the present invention are useful in the manufacture of shaped articles which exhibit dimensional stability.

In preparing the compositions of the present invention, polymer (A) and polymer (B) may be blended in an intimate association to form a uniform, substantially homogeneous blend. The resulting melt often exists in a “single-phase” morphology, which is usually transparent. In contrast, when the processed composition cools and solidifies, the composition may grow increasingly more opaque. This opacity may be due to morphological phase separation or to the appearance of spherulites. The spherulite size of the present invention is typically rather small in these blends which effects an unexpectedly high strength of the blends, since the fracturing of plastics typically occurs along the interfacial boundaries between spherulites, and small spherulites present greater interfacial boundary areas.

The individual components are “intimately associated” through the process of blending, and often melting, i.e. polymer (A) and polymer (B) are intimately associated with an extruder or mixer, or any other form of intensive mixing that results in sufficient polymer interactions to provide a uniform, substantially homogeneous blend, often a melt-blend.

The present invention also relates to the biodegradable and/or compostable polymeric composition in the form of hollow/filled plastic microspheres or small spheres. A process is described, infra, wherein the polymer of the shell of microspheres or small/large spheres is oriented isotropically.

The following mechanism of degradation is presented by way of illustration, and is in no way to be interpreted as limiting the present invention. During the degradation of the plastic containing both amorphous and crystalline regions, it is the former regions which degrade first. A factor important to the degradation of crystalline regions is the glass transition temperature, Tg. If the temperature at composting rises above the Tg, then there is sufficient molecular motion in the molecular chains of the crystalline regions for the rate of degradation to be increased. Since composting conditions can involve 60° C., or even a few degrees higher, an objective of this invention is to create blends with Tgs under 60° C., preferably under 50° C, to ensure that crystalline regions will undergo ready attack. Yet, for ease of fabrication it is also important that the melting point not be too low, such as under 90° C., because plastics with low melting points tend to stick in the fabricating machinery, and have excessively long crystallization times.

The co-continuous phase of the blend facilitates biodegradation which is enhanced over that of the more slowly biodegrading polymer component of the composition polymer (A) due to its consumption by microorganisms, polymer (B) facilitates biodegradation by creating for polymer (A) a greater surface area and access to the interior parts of the plastic through the swelling of the article to a larger size through the mechanism of water absorption. In addition, polymer (B), by serving a concomitant role as a nutrient for microorganism growth, assists the microorganism growth rate.

Polymer (B) is preferably PVOH, and is used in those situations where swelling of the polymer blend is appropriate, particularly PVOH with a degree of hydrolysis within the-range of from about 40% to about 98%, with a range of from about 72% to about 98% being more preferred. The most preferred degree of hydrolysis for the PVOH component of the composition of the present invention is about 83-92%. Ideally, PVOH has a weight average molecular weight (Mw) within the range of from about 10,000 to about 50,000, preferably about 20,000.

As polymer (B), PVOH is most preferred for those products requiring very high tensile properties, or tear strength, and EVOH is preferred for those applications where it is desirable to run the extruder under low backpressure conditions. Other polymers suitable for use herein as polymer (B) include polyesters, such as polylactic acid; polyhydroxyalkanoates, such as polyhydroxybutyrate, polyhydroxyvalerate; Biopol; polycaprolactone; polyethylene adipate; polyethylene succinate; polybutylene succinate; polyglycolic acid; and copolymers and combinations thereof. Additional polymers include polyamino acids, such as polyglycine or polyaspartic acid, or degradable polyurethane, or oxidized polyketones.

An embodiment of the present invention is a blend consisting of several components: a degradable polyesteramide, a polyvinyl alcohol, a starch or polysaccharide, or other natural materials such as cellulosics, or lignins, or chitins.

In the compositions of the present invention, polymer (A) and polymer (B) should be melted and blended together in relative amounts sufficient to prepare a composition that is biodegradable with thermoplastic properties. Polymer (A), the polyesteramide, may be included in the compositions in an amount within the range of from about 20% to 80% by weight of the total composition, and polymer (B) in an amount within the range of from about 10% to about 70% by weight of the total composition. A plasticizer may represent up to 10% of the total composition. The broad range reflects the fact that a composition appropriate for one application may be quite different than that for another application. In some applications, the plasticizer is preferably 0 to 10 wt % of the total composition.

A polysaccharide component may also be included with, or added as an extender or filler to, polymer (A), a degradable polyamide, and polymer (B), e.g., PVOH, and blended therewith to attain a biodegradable thermoplastic polymer blend composition with desirable physical properties and characteristics. Suitable polysaccharide components may be selected from the group consisting of a starch component, celluloses, glycoproteins, alginates, pectins, agaroses, carrageens and combinations thereof. For a more detailed and comprehensive discussion of suitable polysaccharide components, see M. Yalpani, Polysaccharides, Elsevior (1988). A commercially available destructurized starch such as Mater-Bi is a preferred component. Generally destructurized starch is preferred, formed by extruding water and starch, as the destructurized starch forms interpenetrating networks with the other components, and is generally more transparent. The most preferred approach of this invention is to coextrude water, raw starch because of its low cost, and either PVOH or EVOH or a combination thereof, and/or glycerol, and then to extrude this with the polyesteramide in a separate step. Making the destructurized starch in a separate step serves to limit the time the polyesteramide is exposed to high temperature water, thus preserving the molecular weight of the polyesteramide copolymer.

A preferred aspect of this invention is to derivatize starch, or related materials bearing hydroxyl groups, with ethyleneimine, also called aziridine. When starch is heated with aziridine, the aziridine reacts with the hydroxyl end groups thereby forming polyamine end groups. The amine end groups are advantageous as a good nucleophile with which the derivatized starch can graft into other polymers. The amine end-group has little tendency to crosslink between hydroxyls within the starch. This grafting is desirable as it imparts strength to the final plastic at minimal cost.

A composition of the present invention prepared from polymer (A) and polymer (B) may also include a starch component to impart certain physical properties and characteristics to the resulting composition making it particularly advantageous for certain applications, such as for cutlery or golf tees, where rapid disintegration of the processed material is desirable.

Optional components, which may also be added to the compositions of the present invention to impart further desirable physical properties and characteristics, may be selected from, but not particularly limited to, the group consisting of extenders, fillers, lubricants, nucleating agents, mold-release agents, flame retardants, boron-containing compounds, ultraviolet stabilizers, coloring agents, metal salts which catalyze photooxidation, anti-oxidants and combinations thereof.

Also, a plasticizer may optionally be added to the composition of the present invention which tends to form a softer, more readily processable composition. Preferably, the plasticizer component is added in an amount within the range of from about 0.5% to about 10% by weight, and more preferably within the range of from about 0.5% to about 5% by weight. Plasticizers suitable for use herein include low molecular weight polyols, such as polyethylene glycols, polypropylene glycols and polyethylenepropylene glycols, glycerol, butenediol, propylene glycol, sorbitol, and combinations thereof.

Suitable fillers for use herein may include, but are not limited to starch, oxides of magnesium, aluminum, silicon, and titanium; wood derived materials; cellulose fibers, chitin; and combinations thereof. The fillers are present in the composition in an amount of up to 80% by weight.

An excellent degradable pot for plants can be fabricated from 20% polymer as binder (80% polyesteramide(70% caprolactam:30% adipic/1,4-butanediol)/20% PVOH) and 80% peat or sawdust.

Examples of extenders suitable for use herein include, in addition to starch, gelatin, vegetable proteins, sunflower proteins, soybean proteins, cotton seed protein, peanut proteins or rape seed proteins, farinaceous materials, and combinations thereof. While such extenders may be added in any desired amount, preferably they should be added in an amount up to about 20% and more preferably within the range of from about 3% to about 10% by weight of the total composition.

Suitable lubricants for use herein include stearates of aluminum, calcium, magnesium, zinc and tin, as well as their free acids; magnesium silicate; silicones; lecithin; mono-, di- and tri-glycerides, and combinations thereof. Particularly preferred lubricants are stearic acid or lecithin.

During the melt-processing of PVOH, a processing aid is included to prevent thermal degradation. Many processing aids for PVOH are polymers, which for the most part are not biodegradable. One polymer which is an excellent processing aid for PVOH, and which would be biodegradable over a long period of time is polyvinylpyrrolidone. The preferred processing aids are those which are readily biodegradable such as stearamide, or Santicizer 8 (Monsanto, a mixture of o- and p-N-toluene-sulfonamides), or an amidized fat or oil such as corn oil, or soybean oil and the like.

The present invention, in part, includes a compostable and/or degradable polymer composition, comprising: polylactic acid; polymer (B) which is at least one polymer selected from the group consisting of polyethylenevinyl alcohol, polyvinyl alcohol, polyester, starch, starch derivative, cellulose, polyethylene glycol, chitin, amylose, amylopectin, starch derivatized with ethyleneimine, cellulose derivatized with ethyleneimine, polysaccharides derivatized with ethyleneimine, lignin derivatized with ethyleneimine, farinaceous materials derivatized with ethyleneimine and mixtures thereof; component (C) which is a plasticizer; and component (D) which is a crosslinking agent; wherein the polymer composition comprises 0 to 60 wt % of polymer (B), 0 to 25 wt % of component (C), and 0 to 5 wt % of component (D); wherein all wt % values are based upon the total weight of the polymer composition; and with the proviso that the polymer composition must contain at least one of polymer (B) and component (D).

### BRIEF DESCRIPTION OF THE DRAWINGS

FIG. 1 is an apparatus for forming hollow/filled spheres wherein the shell of sphere comprises the biodegradable/compostable polymer of the present invention;

FIG. 2 is a collector comprising a fluidized bed; and

FIG. 3 is an apparatus for shaping the biodegradable/compostable polymer of the present invention in the form of a bulb.

### DETAILED DESCRIPTION OF THE INVENTION

The compostable and/or degradable polymer composition of the present invention comprises:

polymer (A) which is a polyesteramide copolymer;

polymer (B) which is at least one polymer selected from the group consisting of polyethylenevinyl alcohol, polyvinyl alcohol, polyester, starch, starch derivative, cellulose, polyethylene glycol, chitin, amylose, amylopectin, starch derivatized with ethyleneimine, cellulose derivatized with ethyleneimine, polysaccharides derivatized with ethyleneimine, lignin derivatized with ethyleneimine, farinaceous materials derivatized with ethyleneimine, farinaceous materials, and mixtures thereof;

component (C) which is a plasticizer,; and

component (D) which is a crosslinking agent;

wherein the polymer composition comprises 0 to 60 wt % of polymer (B), 0 to 25 wt % of component (C), and 0 to 5 wt % of component (D);

wherein all wt % values are based upon the total weight of the polymer composition; and

with the proviso that the polymer composition must contain at least one of polymer (B) and component (D).

The polymer (A) has an amide content of 80 to 20 wt %, and an ester content of 20 to 80 wt % based upon the mass of the polyesteramide copolymer. Preferably, the amide content is between 80 to 30 wt % and the ester content is between 20 to 70 wt %. Most preferably, the amide content is between 70 to 40 wt % and the ester content is between 30 to 60 wt %.

Polymer (A) can be prepared from at least one of the following sets of reactants:

i) cyclic amide, dicarboxylic acid or ester and aliphatic diol;

ii) aliphatic polyamide and a cyclic ester, a diol or both;

iii) aliphatic diamine, dicarboxylic acid or ester and aliphatic diol;

iv) cyclic amide, dicarboxylic acid or ester, tricarboylic acid or ester, and aliphatic diol;

v) cyclic amide and cyclic ester;

vi) aminocarboxylic acid, dicarboxylic acid or ester and aliphatic diol;

vii) aliphatic diamine and/or triamine, aliphatic diol, dicarboxylic acid or ester and cyclic amide;

viii) aliphatic polyamide and polyester;

ix) polymerized vegetable oil and aliphatic diamine and aliphatic diol;

x) cyclic amide, aminocarboxylic acid, and hydroxycarboxylic acid;

xi) cyclic amide and hydroxycarboxylic acid;

xii) aliphatic polyamide and hydroxycarboxylic acid;

xiii) cyclic amide, cyclic ester, dicarboxylic acid or ester and aliphatic diol;

xiv) a triol/diol/aliphatic dicarboxylic acid crosspolymer and a polyamide; and

xv) triol, diol, aliphatic dicarboxylic acid and a cyclic amide.

In a series of preferred embodiments, polymer (A) is prepared from: polycaprolactam and polylactic acid or lactic acid dimer; caprolactam, caprolactone, and optionally either ethylene glycol or 1,4-butanediol. Ideally, the caprolactam comprises 20-90 wt %, the caprolactone comprises 0-50 wt %, and the diol comprises 5-40 wt % of the total weight of the polyesteramide; and polymerized vegetable oil and diamine, aliphatic diol or both.

In a more preferred embodiment, polymer (A) is prepared from:

caprolactam, adipic acid, and ethylene glycol or 1,4-butanediol and optionally terephthalic acid or ester; hexamethylene-diamine and/or Jeffamine T 403, adipic acid, and ethylene glycol or 1,4-butanediol and optionally terephthalic acid or ester.

An embodiment of the polyesteramide composition of the present invention has 30 to 60 wt % caprolactam, 5-30 wt % adipic acid, 3 to 20% ethylene glycol or 1,4-butanediol and optionally 5 to 20 wt % terephthalic acid or ester.

Another embodiment of the polyesteramide composition of the present invention has 5-40 wt % adipic acid, 3 to 20% ethylene glycol or 1,4-butanediol, 5 to 30 wt % hexamethylenediamine and optionally 5 to 20 wt % terephthalic acid or ester.

In another embodiment, the caprolactam comprises 20-80 wt % and the caprolactone (or lactic units from a cyclic dimer or polylactic acid) comprises 80-20 wt % based upon the mass of the polymeric composition.

In a preferred embodiment, the caprolactam comprises 30 to 70 wt %, 5 to 40 wt % adipic acid and 3 to 20 wt % ethylene glycol or 1,4-butanediol.

The dicarboxylic acid is selected from, but not limited to, Formula I:

HOOC—(CH₂)ₙ—COOH (I)

where n is a whole number ranging from 2 to 6.

The aliphatic diol is selected from but not limited to Formula II:

HO—(CH₂)ⁿ—OH (II)

where n is a whole number ranging from 2 to 6.

The cyclic amide is preferably caprolactam.

The aliphatic polyamide is selected from, but not limited to, the group consisting of nylon-66 and polycaprolactam.

The cyclic ester is selected from, but not limited to, the group consisting of caprolactone and 3,6-dimethyl-1,4-dioxane-2,5-dione.

The aliphatic diamine is selected from, but not limited to, Formula III:

H₂N—(CH₂)ₙ—NH₂ (III)

where n is a whole number ranging from 2 to 6.

The aminocarboxylic acid is selected from, but not limited to, Formula IV:

H₂N—(CH₂)ₙ—COOH (IV)

where n is a whole number ranging from 2 to 6.

The hydroxycarboxylic acid is selected from, but not limited to, Formula V:

HO—(CR₂)ₙ—COOH (V)

where n is a whole number ranging from 2 to 6 and R is selected from the group consisting of hydrogen, methyl and ethyl.

The polyester, which may be a reactant for the preparation of polymer (A) or a component of polymer (B), is selected from, but not limited to, the group consisting of polycaprolactone, polylactic acid, polyhydroxyalkanoate, polyhydroxybutyrate, polyhydroxyvalerate, Biopol, polycaprolactone, polyethylene adipate, polyethylene succinate, polybutylene succinate, polyglycolic acid, and copolymers and combinations thereof.

The compostable, degradable polymer composition of the present invention may further comprise a polyketone, polyurethane, starch, polyethylene glycol or mixtures thereof.

The compostable, degradable polymer composition of the present invention may further comprise a degrading aid. The degrading aid is selected from, but not limited to, the group consisting of ammonium polyphosphate and zinc pyrophosphate, and is preferably in a range of 0.1-5 wt %.

The compostable, degradable polymer composition is preferably in a spherulitic form having an average particle diameter ranging from 100-500 m.

Preferably, polymer (A) has a weight percent amide content is 80 to 20 weight percent, and an ester content of 20 to 80 weight percent.

Preferably, polymer (B) is in a range of 1 to 60 wt % of the total composition.

In an alternative preferred embodiment, polymer (B) is selected from, but not limited to, the group consisting of starch, starch derivative, cellulose, chitin, amylose, amylopectin and mixtures thereof.

Ideally, the compostable, degradable polymer composition of the present invention includes an optionally modified polycaprolactam and polyvinyl alcohol.

An embodiment of the present invention includes a method for preparing a compostable/degradable, polymer composition, comprising combining polymer (A) which is a polyesteramide copolymer with at least one of polymer (B) and component (D); cwherein polymer (B) which is at least one polymer selected from the group consisting of polyethylenevinyl alcohol, polyvinyl alcohol, polyester, starch, starch derivative, cellulose, polyethylene glycol, chitin, amylose, amylopectin, farinaceous materials, and mixtures thereof;

component (D) which is a crosslinking agent;

in an amount necessary to have up to 60 wt % of polymer (B) and up to 5 wt % of component (D);

wherein all wt % values are based upon the total weight of the polymer composition.

Preferably, polymer (A) is prepared prior to said combining step from at least one of the following sets of reactants:

i) cyclic amide, dicarboxylic acid or ester and aliphatic diol;

ii) aliphatic polyamide and a cyclic ester, a diol or both;

iii) aliphatic diamine, dicarboxylic acid or ester and aliphatic diol;

iv) cyclic amide, dicarboxylic acid or ester, tricarboylic acid or ester, and aliphatic diol;

v) cyclic amide and cyclic ester;

vi) aminocarboxylic acid, dicarboxylic acid or ester and aliphatic diol;

vii) aliphatic diamine and/or triamine, aliphatic diol, dicarboxylic acid or ester and cyclic amide;

viii) aliphatic polyamide and polyester;

ix) polymerized vegetable oil and polyester, aliphatic diol and diamine or both;

x) cyclic amide, aminocarboxylic acid, and hydroxycarboxylic acid

xi) cyclic amide and hydroxycarboxylic acid;

xii) aliphatic polyamide and hydroxycarboxylic acid;

xiii) cyclic amide, cyclic ester, dicarboxylic acid or ester and aliphatic diol;

xiv) a triol/diol/aliphatic dicarboxylic acid crosspolymer and a polyamide; and

xv) triol, diol, aliphatic dicarboxylic acid and a cyclic amide.

In one embodiment polymer (A) is prepared by melting an aliphatic polyamide and blending at least one hydroxycarboxylic acid selected from Formula V:

HO—(CR₂)ₙ—COOH (V)

where n is a whole number ranging from 2 to 6 and R is selected from the group consisting of hydrogen, methyl and ethyl.

Additionally, polymer (A) is prepared by melting an aliphatic polyamide and either a polyester or cyclic ester together and mixing for greater than one minute in the melt.

Furthermore, polymer (A) can be prepared by combining a cyclic amide, a cyclic ester, and water, wherein the cyclic amide ranges from 98 wt % to 20 wt % and the cyclic ester ranges from 2 wt % and 80 wt %, and the amount of water ranges from 1-3 wt %.

In another embodiment, polymer (A) is prepared from a cyclic amide, which is caprolactam, a cyclic ester which is caprolactone, a dicarboxylic ester which is dimethylterephthalate and an aliphatic diol which is selected from the group consisting of ethylene glycol and 1,4-butanediol. Ideally, the caprolactam is 20-80 wt %, caprolactone is 0-40 wt %; dimethylterephthalate is 5-40 wt %, and ethylene glycol is 5-40 wt % of the total composition.

The present method for the preparation of polymer (A) further comprises the option of adding tin octoate to the melted mixture.

In another embodiment, polymer (A) is prepared by combining a cyclic amide, a cyclic ester, and an anionic catalyst, wherein the cyclic amide ideally ranges from 80 wt % to 20 wt %, the cyclic ester ideally ranges from 20 wt % and 80 wt %, and the anionic catalyst varies between 20-5,000 ppm.

The anionic catalyst is sodium methoxide and/or the sodium salt of caprolactam.

In a preferred embodiment, polymer (A) is prepared by combining caprolactam, adipic acid, and either ethylene glycol or 1,4-butanediol. Caprolactam ranges from 80 wt % to 20 wt %, and the adipic acid and diol comprise 20 wt %.

In another preferred embodiment, polymer (A) is prepared by combining hexamethylene diamine with adipic acid and either ethylene glycol or 1,4-butanediol. In this instance the molar amounts of the sum of the diamine and diol equals the molar amount of the adipic acid. The composition is balanced so as to enable the ester content to be in the range of 20-80%.

In another preferred embodiment, polymer (A) is prepared by combining hexamethylene diamine and caprolactam with adipic acid and either ethylene glycol or 1,4-butanediol. In this instance the molar amounts of the sum of the diamine and diol equals the molar amount of the adipic acid. The composition is balanced so as to enable the ester content to be in the range of 20-80%.

In a still more preferred embodiment, polymer (A) is prepared by combining caprolactam, adipic acid, trimelletic acid, and either ethylene glycol or 1,4-butanediol. Caprolactam ranges from 80 wt % to 20 wt %, and the adipic acid and diol comprise 20 wt %. The ratio of adipic acid to trimelletic acid is in the range of 9.0:1.0 to 50:1. The trimelletic acid is present as a crosslinking site. The composition is balanced so as to enable the ester content to be in the range of 20-80%.

In another more preferred embodiment, polymer (A) is prepared by combining hexamethylene diamine, Jeffamine T 403, or Jeffamine T 5000 with adipic acid and either ethylene glycol or 1,4-butanediol. In this instance the molar amounts of the sum of the diamine, triamine and diol equals the molar functionality of the adipic acid. The diamine to triamine ratio is between 9.0:1.0 to 50:1. The triamine is present as a crosslinker. The composition is balanced so as to enable the ester content to be in the range of 20-80%.

An approach of this invention for tailoring the physical properties to a particular end-use is to crosslink the copolymers. The physical properties of the biodegradable/compostable polymeric composition will depend upon the concentration and the type of the crosslinking agent and upon the point in the preparation wherein the crosslinking agents are added.

In general, the biodegradable/compostable polymer composition of the present invention includes a polyesteramide and a polymer containing pendant alcohol groups such as polyvinyl alcohol. The preparation of the polymer composition includes any of the following pathways: i) reacting the crosslinking agent with the polyesteramide followed by addition of the polyalcohol; ii) reacting the crosslinking agent with the polyalcohol followed by addition of the polyesteramide; or iii) reacting the crosslinking agent with a combination of polyesteramide and polyalcohol. Each one of these pathways will result in products having different physical properties.

Crosslinking agents having either an alcohol or amine functionality will react with the ester and amide linkages of the polyesteramides and will act to crosslink the polyesteramides. These include triamines, especially preferred are the Jeffamines T 403 and T 5000, multifunctional amines, polyethyleneimines, triaminopyrimidines, tetraazacyclotetradecane and amino resins (such as melamine resins and blocked polyisocyanates). Polyols include triols such as glycerol, 1,1,1-tris(hydroxymethyl)ethane or triethanolamine, and sorbitol, EVOH, PVOH, butylglycol (melamine/formaldehyde resin polypropylene glycol) or combinations thereof.

Generally, amines are more efficient than alcohols in reacting with the amide and ester moieties due to a higher nucleophilic character. An exceptional crosslinking agent is a JEFFAMINE (sold by Shell Inc.).

Crosslinking agents having either an epoxide or an isocyanate functionality will react with an amine or an alcohol group. This is exemplified by methylene bis(4-phenyl isocyanate). Crosslinking agents having an epoxide functionality will react with an amine or an alcohol group. These are exemplified by diethylene glycol diglycidyl ether and epichlorohydrin.

Crosslinking agents having an acid or ester functionality will react with an ester, amide, amine and alcohol group. These include tricarboxylic acid/ester, tetracarboxylic acid/ester and end-capped methacrylate functionalized polyethyleneglycol.

A crosslinking agent with mixed functional groups allows for the possibility of selective attachment to different functional polymers. A crosslinker especially preferred is 3-trimethoxysilyl-1-propanamine because the amine end can form amide links with the polyesteramide either through reaction with free carboxylic acid groups or through amide exchange, whereas the silyl ether end is more selective in derivatizing alcohol moieties. Thus this crosslinker is especially good at intermolecular crosslinking between PVOH or starch and the polyesteramide. This leads to a significant improvement in the strength.

A preferred approach to incorporating starch into a biodegradable plastic is to derivatize the starch with ethyleneimine prior to blend with the plastic. Treatment of the starch leads to amine end-groups, which will be effective in bonding with the plastic. Since mechanical failure in a plastic is between phases, these tie units strengthen the overall product very significantly. Starch may be dried or undried before being treated with etyhylenimine. The product, consisting of derivatized starch and polyethyleneimines, can be used without purification in blending with a biodegradable plastic. The advantage of this approach from an economic viewpoint is the starch additive is of low cost and able to impart considerable strength to the overall product, and yet biodegrade rapidly. This route is especially preferred for products that need to be strong and readily biodegradable.

Crosslinking agents having metal cation will react with an acid group and act as a salt bridge which is easily cleaved by the action of eg., ammonia. These include zinc pyrophosphate and zinc oxide.

Radiation curing is advantageous in the specific instance for post-fabrication crosslinking. To make very tough blown films, the radiation curing is performed after fabrication of the film. This allows for the generation of a high level of crosslinks. Radiation curing is especially effective with vinyl crosslinkers.

The ease of processing is an important factor in choosing the type of crosslinking agents. The crosslinking agent has a weight average molecular weight of 100-1,000,000, preferably the crosslinking agent has a weight average molecular weight of 100-100,000. The crosslinking agent has at least two active sites for reacting with the degradeable and/or compostable polymers. These active sites include alcohols, silanols, cyanates, isocyanates, epoxides, ethers, alkoxy silanes, esters, amines, substituted silicon oxides, olefins, and ureas.

The following compounds (by Registry Numbers) are preferred: 210418-00-1, 207802-95-7, 3293-02-5, 183787-07-7, 141-63-9, 183787-07-7, 7445-36-5, 170694-41-4, 170694-42-5, 170694-43-6, 170694-44-7, 170694-45-8, 170694-45-9, 170694-47-0, 170694-48-1, 170694-49-2, 170694-50-5, 3081-07-0, 116753-85-6, 138001-69-1, 138001-70-4, 138024-24-5, 133838-29-6, 82753-23-9, 82771-08-2, 13822-56-5, 2602-34-8, 2530-83-8, 919-30-2, 13236-02-7, 26403-72-5, 2224-15-9, 4098-71-9, 3454-29-3, 39423-51-3, 64852-22-8, and 78491-02-8. Mixtures of these compounds are contemplated. The siloxanes can be further derivatized by the addition of an epoxide such as epichlorohydrin.

Starch used in the invention may include starch which is treated with a number of multifunctional crosslinking agents such as disclosed in “Starch Derivatives: Production and Uses” by M. Rutenberg and D. Solarek, Starch: Chemistry and Technology, Chapter X, pp. 324-332, 1984. Such crosslinking agents include bifunctional etherifying and/or esterifying agents such as epichlorohydrin, bis-.beta.-chloroethyl ether, dibasic organic acids, phosphorous oxychloride, trimethaphosphate (i.e., the alkali and alkaline earth metal salts), linear mixed anhydrides of acetic and di- or tribasic carboxylic acids. Another useful crosslinking agent is sodium hypochlorite, which when used in the proper amount and under proper pH conditions (11 or more) provides crosslinked starch. Preferred crosslinking agents are epichlorohydrin, phosphorous, oxychloride, adipic-acetic anhydrides and sodium trimetaphosphate, with epichlorohydrin being most particularly preferred. An important feature of this invention is the amount of crosslinking that the starch receives, i.e. the amount of treatment of the degree of crosslinking. It is difficult to measure this characteristic of the treated starch.

In order to determine the amount of crosslinking which has been provided to the treated starch is to measure the viscosity of the starch. It is well known in the art to measure the viscosity of crosslinked starch using a C.W. Brabender viscoamylograph.

Preferably, the crosslinking agent is incorporated at a level of from 0.0 to about 5.0 wt % based upon the total weight of the polymeric composition. More preferably, the crosslinking agent is incorporated from 0.0 to 2.0 wt %. Alternatively expressed, the crosslinking agent may be added at a concentration of 20 -50,000 ppm, preferably in the amount of 20-3,000 ppm. This concentration gives sufficient crosslinking and provides for excellent tear properties, which is particularly important in films.

An aspect of the present invention is to prepare block copolymers. Polymers which are end-capped with either an alcohol group or an amino group could react with the ester or amide groups of the polyesteramide to form block copolymers in reaction such as transesterification or transamidation. Examples of useful polymers having functional groups on the ends of the polymers include polyether diols such as polyethylene glycol, polyethylene ether glycol, polypropylene ether glycol, polytetramethylene ether glycol, polyhexamethylene ether glycol, polysilylalcohols, polyesteramidepolyols, polyurethanepolyols, hydroxylated acrylate resins and mixtures or copolymers thereof; polyester diols such as polybutylene adipate glycol, polyethylene adipate glycol and mixtures or copolymers thereof; and aminoalkyl-terminated polyethylene glycol such as aminopropyl-terminated polyethylene glycol and aminopropyl-terminated polypropylene glycol.

Preferred polymers having functional groups on the ends of the polymers are polyethylene glycol, aminopropyl-terminated polyethylene glycol and polysilylalcohols and have a molecular weight of 600 to 2000 dalton. Silicones and PEGs aid during processing, and PEGs add to the softness of the article, and are themselves biodegradable. Both silicones and PEGs can be derivatized with epichlorohydrin to form an alternative effective crosslinking agent. When polypropylene glycol or aminopropyl-terminated polypropylene glycol are used, it is preferred to maintain the molecular weight to 1000 to 4000 dalton. When an elastic material is needed, this can be accomplished by using a derivatized (e.g., with epichlorohydrin) PEG with molecular weight over 10000 dalton. The soft segments of the PEG when bound to hard segments, provides elasticity. Achieving a high level of elasticity will require using 20-40% of high molecular weight PEG.

Additionally, the compostable, degradable polymer composition, comprises:

a polymer (A′) comprising alcohol hydroxy groups grafted and/or crosslinked with a polymer (A″) comprising amide groups. These are combined by an ester linkage formed from a carbonyl of polymer (A″) bonding to a dehydrogenated hydroxyl oxygen atom from polymer (A′). The compostable, 1.0 degradable polymer composition is further characterized in that 10-99 wt % of polymer (A″) is not bound to polymer (A′), and the ester and amide linkages along the polymer backbone are in an ester/amide ratio of 0.01-1.0.

Preferably, polymer (A′) is in a range of 1 to 80 wt % of the total composition, and the hydroxyl groups of polymer (A′) are at least 0.1 wt % of polymer (A′) before grafting and/or crosslinking, more preferably in the range of 0.1-40 wt % of polymer (A′) before grafting and/or crosslinking, most preferably in the range of 14 -39 wt % of polymer (A′) before grafting and/or crosslinking.

The present invention, in part, includes a compostable and/or degradable polymer composition, comprising: polylactic acid; polymer (B) which is at least one polymer selected from the group consisting of polyethylenevinyl alcohol, polyvinyl alcohol, polyester, starch, starch derivative, cellulose, polyethylene glycol, chitin, amylose, amylopectin, starch derivatized with ethyleneimine, cellulose derivatized with ethyleneimine, polysaccharides derivatized with ethyleneimine, lignin derivatized with ethyleneimine, farinaceous materials derivatized with ethyleneimine and mixtures thereof; component (C) which is a plasticizer; and component (D) which is a crosslinking agent; wherein the polymer composition comprises 0 to 60 wt % of polymer (B), 0 to 25 wt % of component (C), and 0 to 5 wt % of component (D); wherein all wt % values are based upon the total weight of the polymer composition; and with the proviso that the polymer composition must contain at least one of polymer (B) and component (D).

The present invention, in part, includes the polylactic acid combined with starch which has been derivatized with a crosslinking agent. Preferably, the crosslinking agent is ethyleneimine and the ratio of the relative weight percent of polylactic acid to the derivatized starch ranges from 0.02 to 99.9. More preferably, the ratio is 0.2 to 5.

The compostable, degradable polymeric composition of the present invention may be prepared in the form of a film, an injection molded article, a monofilament, a fiber and a manufactured article amongst others known to the artisan.

The present invention is directed to polymeric compositions that are degradable and can be melt processed into various forms, including films, fibers, nonwovens, molded and thermoformed materials. The compositions have melt strengths and set times that enable products to be directly formed by conventional melt processing techniques. In addition, the compositions provide products having physical integrity and substantially uniform physical properties, including mechanical properties.

As used herein, the product has physical integrity if it is substantially free from physical defects or flaws which significantly reduce the utility of the product for its intended application, and further is substantially whole in its intended form (i.e., integral). Flaws or defects include, for example, holes, tears, breaks, cracks, folds, nonuniformities in thickness, distortions in shape, and the like, which significantly reduce the utility of the product for its intended application.

Products of preferred polymeric compositions also have thermomechanical integrity up to a given temperature that is above room temperature. As used herein, room temperature refers to temperatures in the range of 20° C. to 25° C.

As used herein, a product of a polymer or composition has thermomechanical integrity up to a given temperature if it maintains sufficient physical integrity upon exposure to the use temperature it performs adequately over the intended lifetime of the product. It is to be understood that the intended application may be at room temperature, or above, or below room temperature. In general, the product must remain strong enough that it is suitable for use in its intended application after exposure to that temperature, as well as be stable under the range of temperatures the product is exposed to during its lifetime.

As will be understood by the skilled artisan, thermomechanical integrity is a function of the conditions of exposure, including time and temperature, that would be expected to be realized for a given application. Thus, strength retention tends to depend on the length of time of exposure to the temperature that is above room temperature. In general, for a given exposure time, the strength decreases to a greater extent and more rapidly as the exposure temperature increases. On the other hand, under nonequilibrium conditions the strength decreases to a greater extent as the exposure time increases, for a given exposure temperature.

The thermomechanical integrity of a polymeric product can be described by the failure temperature of the product. In general, the failure temperature as used herein is the temperature at which the dynamic storage modulus in tension of a polymer product falls below a minimum value required for the product to function in its intended application, (including secondary processes such as conversion processes, and end use applications). The dynamic storage modulus in tension of a polymeric product as a function of temperature can be determined using a dynamic mechanical analysis technique as described herein (the dynamic storage modulus in tension is alternatively referred to herein as DSM). The failure temperature can then be determined by noting the temperature at which the DSM falls below the value that is required for the product to function in its intended application.

Typically, the DSM of a polymeric product decreases monotonically with increasing temperature, and the polymer product will exhibit a significant, maximum decrease in the DSM which is initiated at or near transition points such as the glass transition temperature and the failure temperature. However, the decrease in DSM that begins at or near the failure temperature is greater than at other temperatures. Typically, the change in DSM that occurs beginning at or near the failure temperature is on the order of at least two orders of magnitude, as measured in MPa, over a positive temperature change of about 10° C.

The failure temperature of polymeric films or fibers that are to be used in disposable absorbent articles, for example, as backsheets or in topsheets, respectively, is the temperature at which the DSM of the film or fiber falls below 20 MPa. Preferred compositions of the present invention provide polymeric films or fibers having a failure temperature of at least about 70° C., more preferably at least about 90° C., even more preferably at least about 110° C., most preferably at least about 120° C. One method for tailoring the failure temperature to acceptable levels, is by varying the percent of amide linkages in the polyesteramide.

The compositions used to prepare the biodegradable products herein are derived from specific combinations of two or more compostable/biodegradable polymers. As used herein in reference to polymer components and compositions, “biodegradable,” “biodegradability”, “biodegradation” and the like means the capability of undergoing natural processes in which a material is broken down by metabolic processes of living organisms, principally fungi and bacteria. In the presence of oxygen (aerobic biodegradation), these metabolic processes yield carbon dioxide, water, biomass, and minerals. Under anaerobic conditions (anaerobic biodegradation), methane may additionally be produced. The polymeric compositions of the present invention demonstrate a loss of physical properties upon exposure to conditions approximating the initial phase of composting, i.e., three days in the reactor. The present compositions also exhibit mechanical loss of properties during composting, so the material qualifies as compostable.

In general, the biodegradable polymers of the prior art do not themselves possess all of the performance standards required for practical application. The failure of individual polymers over the course of past ten years to capture significant market share is proof of this reality. More particularly, the individual polymers may not possess a melt strength or crystallization time which is suitable for good melt processing, which is an economically preferred method of forming the types of polymeric products described herein. In addition, the products of the individual polymers may not have sufficient physical properties, including mechanical properties, to withstand subsequent processing, or for use in certain applications. In addition, a given polymer may not possess physical properties, such as tensile properties, tear strengths, impact strength, and a moisture transmission rate, which are preferred for a particular end use. Moreover, the products of the individual polymers may not have thermomechanical integrity, such that the product avoids an unacceptable loss in physical integrity or physical properties upon exposure to elevated temperatures, for example, during conversion or storage.

The individual polymers selected for the products of the present invention include both natural and synthetic polymers which are biodegradable. Each of the polymers has one or more attributes which render it biodegradable. However, many of these attributes prevent the polymer from being used singularly as a material in certain biodegradable, and/or compostable products.

For example, some biodegradable polymers are moisture sensitive. As used herein a “moisture sensitive polymer” means that the polymer, when exposed to aqueous media, may absorb significant amounts of water, usually, more than about 10% by weight, resulting in swelling, loss of strength and possible dissolving. Products based on starch or PVOH often fall into this category. The moisture sensitivity of materials to be used in absorbent articles is important, for example, insofar as it relates to the ability of the material to maintain its integrity during use of the article or to serve as a moisture barrier layer. For example, a film for use as a moisture barrier layer, e.g., a backsheet, preferably has a moisture transport rate of less than about 0.0012 grams per square centimeter per 16 hours. Examples of moisture sensitive polymers include interpenetrated networks of destructurized starch, polyvinylalcohol and related derivatives such as thermoplastic polyvinylalcohol compositions, and hydroxypropylcellulose and its derivatives.

The solution to the diaper backsheet problem can take at least two forms: one is to create a biodegradable polymer which meets the water transmission requirements; the other is to use bilayer or multilayer film comprising biodegradable polymers and a layer with low water transmission rates to serve as a barrier. Given the technology of this application it is possible to make a spectrum of products with regard to water transmission rates, but the challenge for diaper backsheet is to make a product which degrades at a rapid rate which has low water transmission rates. These two concepts must be considered to be in conflict. Plastics with low water transmission rates tend to degrade slowly. The alternative path preferred in this invention is make a completely biodegradable product by generating a tri-layer product consisting of layer of low molecular weight (<5,000 Mw), hydrophobic material sandwiched between two layers of biodegradable polymer. This center layer could include biodegradable materials such as waxes, especially carnauba wax or beeswax, or a fat or hydrogenated oil, or solid polyethylene glycols, or polyethylene, or polypropylene or polyethyleneterephthalate. Some tying of the layers is normally required. If complete biodegradability is not required for the product, any low water transmission rate polymer could be used in the bi- or multilayer film.

Other biodegradable polymers suffer from thermal sensitivity at relatively low process and/or storage temperatures. As used herein, “thermally sensitive polymer” means a polymer having a melting point of below about 65° C., an amorphous polymer having a glass transition temperature of less than about 65° C., or a polymer having a Vicat softening point of less than about 45° C. Such polymers are thermally sensitive due to these relatively low melting points or glass transition temperatures. Such polymers tend to exhibit thermoplastic flow at temperatures above their melting point or glass transition temperature and as a result are thermomechanically limited. In addition, products formed from these polymers may lose their shape during storage at elevated temperatures. Examples of thermally sensitive polymers include aliphatic polyesters such as polycaprolactone, polyethylene adipate, polybutylene glutarate, and polypropylene succinate. Some aliphatic polyester-based polyurethanes are thermally sensitive as defined herein. In addition, polylactides may be thermally sensitive, depending on their structures. For example, non-crystalline polylactide, e.g., atactic polylactide or unannealed isotactic polylactide, tends to be thermally sensitive.

Still other polymers have mechanical deficiencies. By “mechanically limited polymer” it is meant that a product formed from the polymer is too stiff (tensile modulus too high), too soft (tensile modulus too low), suffers from poor tensile and/or tear strengths, and/or has insufficient elongation properties to enable its use in a given application. On the other hand, there are polymers or compositions that are not mechanically limited and provide products that do not suffer from these limitations. For example, it is preferred that films for use in disposable absorbent articles and having a thickness of from about 12 microns to about 75 microns have, at room temperature, a machine direction (MD) tensile modulus from about 10,000 to about 106000 lbs/in²; a MD tear strength of at least 25 grams per micron of thickness; a cross direction (CD) tear strength of at least 25 grams per 25.4 microns of thickness; and an impact strength of at least 12 cm as measured by falling ball drop; and more preferably also have, at room temperature, a tensile elongation at break of at least about 140% and a tensile strength of at least about 20 MPa. In the context of films, the mechanically limited polymers form films of the above-noted thickness having at least one of these properties outside of the stated ranges. Examples of mechanically limited polymers include cellulosic materials such as cellophane, cellulose esters, some blends of cellulose esters with aliphatic polyesters, polylactides, certain polyhydroxyalkanoates (e.g., PHBV copolymers), and some thermoplastic polyurethanes.

Other polymers are difficult to process by conventional melt processes, e.g., by cast film extrusion, blown film extrusion, and melt spinning processes, into films, fibers or other forms having physical integrity. By “difficult to melt process,” it is meant that the polymer melt strength and/or set time that detracts from the ability to form products having physical integrity by a conventional melt extrusion process.

The effective melt strength refers to the resistance of a molten polymer to be drawn-down to a desired dimension such as thickness (the case of films), or diameter or denier (in the case of fibers). A polymer having a low effective melt strength is unable to withstand the minimum strain that is required to draw the polymer melt to a desired dimension. For example, a polymeric material may exhibit instabilities such as breakage, sagging, or draw resonance. The resultant products tend to be highly nonuniform in physical integrity, e.g., the products have significant nonuniformities in thickness or shape.

The set time refers to the time period required, under a given set of process conditions, for the molten polymer material to achieve a substantially non-tacky physical state. The set time is important since blocking may occur if the polymer does not set within a suitable time during processing. Thus, the polymeric material having residual tack may stick to itself and to processing equipment even after cooling to room temperature or below. Such residual tack may restrict the speed at which the product can be processed or prevent the product from being collected in a form of suitable quality. Although blocking may be minimized by the use of conventional anti-block agents, it may sometimes be desirable to avoid the use of these agents, such that the polymer set time becomes especially important. For example, mineral anti-block agents such as talc, silica and the like may be required in relatively high levels in order to provide a sufficient anti-block effect. However, at such high levels, the anti-block agent can negatively impact the mechanical properties of the product for a given application, e.g., the modulus may become too high or the tear and tensile strength may become too low. This change in properties usually becomes unacceptable when such anti-block agents are used at a level of over about 5-10 weight % of the composition. In addition, it may be desired to avoid the use of an anti-block agent where the agent is not environmentally inert or biodegradable, where the agent is potentially toxic, or where the agent interferes significantly with heat sealing properties or other properties of the polymeric product.

The set time is influenced by the polymer material and the processing equipment and conditions. In general, the set time should be on the order of seconds under conventional process conditions. Such conditions typically include temperatures ranging from that of chill rolls, such as are known in the art, to the melt temperature of the material being processed, which may be up to about 60° C. In general, longer process cycle times (e.g,, from the point of melt extrusion to the point of take-up or collection) tend to accommodate longer set times. For example, cast film processes tend to accommodate compositions having a relatively long set time, as compared to blown film processes. An advantage of the polyesteramide copolymers is the set times are typically short, providing greater flexibility to the fabricator.

For semi-crystalline polymers, the set time depends on the rate of crystallization of the polymer or on the glass transition temperature (i.e., Tg) of the polymer. For amorphous polymers, the set time depends on the glass transition temperature of the polymer. In general, if the Tg is above the temperature of the polymer during the later stages of shaping, the set time is virtually immediate as a result of vitrification. For semicrystalline polymers with a Tg below the temperature at the time of shaping, a suitable set time is generally achieved where the radial growth rate is at least about 1 micron per second. The radial growth rate is the rate at which the radius of a growing spherulite increases with time. A spherulite is a spherical aggregate composed of crystalline lamellas ranging in size from submicroscopic to a diameter on the order of millimeters.

Polymers that tend to be difficult to melt process are exemplified by polycaprolactones, polyhydroxybutyrates, and PHBV copolymers (polyhydroxybutyratevalerate copolymers, e.g., Biopol), polylactic acid, and thermoplastic polyurethanes having a Tg below the temperatures typically employed by melt shaping. Such polymers are primarily limited by their relatively long set times at typical melt process conditions. Other polymers that tend to be difficult to melt process are polyhydroxy alkanoates, for example, polyhydroxybutyrate and polyhydroxybutyrate/valerate copolymers. Such polymers are primarily limited by their relatively low melt strength, stickiness in the melt, and long crystallization times.

Yet other biodegradable polymers possess many or all of the physical properties desired for certain applications, such as in disposable absorbent articles, but are less suitable for use in products that are to be composted. This is because the polymers do not degrade fast enough to break up into small fragments in the early stages of composting. Hence, there is a strong likelihood that such polymers would be screened out of the compost stream and not become part of the final compost. Several of such polymers have a melt point or Tg that is above the temperatures typically encountered in commercial composting units, e.g., above about 65° C. Examples of such polymers include hydrolytically cleavable polyesters. Hydrolytically cleavable polyesters suitable for use herein are polyesters that are cleaved to low molecular weight, biodegradable fragments via reaction with water, or water at acid or basic pH, particularly at temperatures above 65° C. Polymers of this type include the aromatic aliphatic polyester copolymers described herein, oxidized ethylene/carbon monoxide copolymers, oxidized polyketones, and aliphatic polyesters with melting points or glass transition temperatures above about 65° C. such as those described herein.

A particularly challenging type of degradable polymer is one which can be used for articles used as absorbent materials, e.g., diaper backsheet. The difficulty with nylon-6, by illustration, is its water transmission rate, which is considered to be too high for use in this article, therefore the diaper is wet on the outside. What is needed for this application is a material which has a low rate of water transmission, but which is degradable. In this context, the present invention includes a number of candidate approaches such as blends of polyesteramide with more hydrophobic polymers, novel polymers based on amide/terephthalate/alcohol comonomers, or amide/degradable ester/terephthalate/alcohol comonomers, and coating degradable polymers with hydrophobic materials.

Since each application has a different set of desired characteristics, such as tear strength, flexibility, hardness, rate of degradation, etc., there is a need for a polymeric material which can easily be tailored to have the appropriate characteristics for a particular application. The present invention meets this need by providing a blend of a polyesteramide and an alcohol-containing polymer.

Categories of Useful Polymers

Polymers which are useful in forming the compositions of the present invention can be classified as follows. It will be understood by the skilled artisan that certain polymers may be classified in more than one group.

A. Polyamides

Polyamides such as nylon-6 are not considered to be biodegradable. The basis for this is very straightforward: the molecular weights of the polyamide chains in a polyamide plastic are too high to be readily attacked by microorganisms. Polyamides of synthetic monomers with molecular weights under 1000 are readily biodegradable, but have no plastic properties. One approach to making polyamides biodegradable is to use monomer units based upon naturally occurring amino acids. Nature has developed ways of handling high molecular weight chains provided they consist of naturally occurring amino acids, illustrated by protein metabolism. Other approaches include polyglucaramides, which are prepared in U.S. Pat. No. 5,473,035 (Kiely) and related earlier patents, herein incorporated as references. Canadian Patent Specification 975,491 describes photodegradable polyamides which contain keto groups in the side chain. European Patent Application EP 0 347,687 specifies photodegradable polyamides with keto groups in the main chain. U.S. Pat. No. 5,272,221 (Kitao) teaches that physically mixing a low-molecular weight polyester with a polyamide results in a degradable product.

The approaches described above to making biodegradable polyamides do have some disadvantages. Polyamides based upon amino acids, or models of amino acids, are expensive and tend to have poor plastic properties. Polyamides in which keto groups, either in the side chain or the main chain, are intended to degrade to lower molecular weight fragments via Norrish reactions; however, fragments also form Schiff bases via condensation of amines and ketones, giving discoloration of the product well before it has degraded substantially. When degradable polyesters, as in U.S. Pat. No. 5,272,221 (Kitao), are simply mixed with polyamides and then tested for degradability, what is actually degrading is the polyester portion of the blend, leaving behind the polyamide chains which are much slower to hydrolyze into fragments small enough to be metabolized by natural biota.

An approach to making polyamides degradable over an extended period of time for use in commercial fishing nets is disclosed in U.S. Pat. No. 5,457,144 (Holy). To produce the polyesteramide required the use of a catalyst, zirconium acetylacetonate. The polyesteramide plastics of the present invention are much improved over these polyesteramides. It has also been discovered that the approaches described herein apply to all commercially available polyamides, whether they are of AB type or AABB type. Useful polyamides (nylons) include both semi-crystalline and amorphous polymers. The polyamides used in the present invention include those semi-crystalline and amorphous resins having a molecular weight of at least 5000 and are commonly referred to as nylons. Suitable polyamides include those described in U.S. Nos. 2,071,250; 2,071,251; 2,130,523; 2,130,948; 2,241,322; 2,312,966; 2,512,606; 3,93,210; and 4,369,305. The most preferred monomer for most applications is caprolactam because it more readily makes polymers with melting points low enough to allow for blends of thermally sensitive materials such as PVOH or starch. Adipic-based materials are more desirable for products requiring exceptional strength or high service temperatures.

Preparing a polyamide in which ester units occur regularly in the polymer yields a material which is susceptible to hydrolytic cleavage. Cleavage at the ester linkages yields fragments of polyamide much shorter than that of the original chain, and biological processes are much more facile in consuming these chain fragments. The greater the ester content, the smaller the chain fragments which are derived from the breakdown of the chain. The greater the ester content, the more rapid the degradation of the plastic. On the other hand, the greater the amide content, with some unexpected exceptions, the greater the strength. There are some compositions, typically at ester contents under 10% where the copolymer is actually stronger than the amide homopolymer.

The hydrolysis can be catalyzed by the pH conditions in the microenvironment of the polymer, or by microorganisms. Especially in the blends designed herein, where there are readily degradable materials in intimate contact with the polyesteramide chains, e.g., PVOH to swell the region, or starch, a microenvironment is created for an acceleration of degradation. Further addition of catalysts such as ammonium pyrophosphate facilitate degradation.

In preparing a polyesteramide of the AABB type, the ester functionality can be incorporated most conveniently during the initial synthesis of the polymer. In a typical synthesis of nylon-6/6 a salt slurry of the diamine and the dicarboxylic acid is heated to condense the units into a polymer having all or essentially all amide linkages. What is disclosed in this work is that a portion of the diamine can be replaced with a diol and the condensation can then be effected to form both amide and ester linkages. The greater the degree to which the diamine is replaced with diol, the greater the ester content. When selecting a diol it is useful to select one having a reasonably low vapor pressure, such as 1,4-butanediol or 1,6-hexanediol, in order that the diol not become fugitive during the condensation process, often involving temperatures up to 280° C. The condensation can be done at ambient pressure or under pressure or under vacuum. The unreacted monomer may then be stripped by extraction with water or under vacuum. In addition to 1,4-butanediol and 1,6-hexanediol, other diols such as 1,2-ethanediol, 1,3-propanediol, and the like are suitable for preparing polyesteramides.

The esterifying agent does not have to be a diol. A hydroxy acid, or a polymer thereof, can serve as esterifying agent to the polyamide. This is illustrated by the use of caprolactone as monomer, or polycaprolactone, to replace some portion of the adipic plus diamine in the synthesis of a material related to nylon-6/6. Caprolactone, polycaprolactone, or oxidized polyketone can also serve as a source for the ester unit to be scrambled into nylon-6. Other salt mixtures of the nylon-6/6 type would include adipic acid and hexamethylenediamine and terephthalic acid (plus a diol), or glycolic acid or lactic acid or 3-hydroxybutyric acid, or 4-hydroxybutyric acid or 3-hydroxyvaleric acid. Upon dehydrating the salt under favorable conditions, molecular weights in excess of 20,000 Mw can be obtained in which the ester content is distributed in the chains according to the individual equilibrium condensation constants. The ester units are more or less random in their distribution along the chain, and ester-ester linkages are also formed as higher levels of hydroxyacids are incorporated into the polyamide chain.

The polyamide of the composition may be selected from the group consisting of synthetic polyamides such as nylon-6, nylon-6/6, nylon-6/12 or similar commercially available products, or of polymers of amino acids. The polyamide may also come from the condensation of diacids derived from naturally occurring materials such as fatty esters. Polyamides derived from these naturally occurring materials were commercially significant some years ago, but are now almost absent from the marketplace. Nonetheless, polyamides of these materials are very acceptable for applications addressing the issue of biodegradability. Any polyamide derived from natural materials serve as excellent raw materials for degradable plastics.

The polyamide may also be of the AB-type. The most common synthetic polyamide of this type is nylon-6. Ester linkages may be incorporated into AB-type polyamides by replacing a portion of the amide monomer with a lactone, hydroxyacid, or diacid such as adipic acid or maleic acid or maleic anhydride, along with diol. For example, a polyesteramide can be prepared by condensing caprolactam and caprolactone. The condensation, if done with water as catalyst, proceeds more slowly than with caprolactam monomer alone. The condensation rate can be enhanced by raising the temperature by 10-20° C. above the normal temperature used for caprolactam alone. This does not introduce color into the product in a reactor of commercial size. The melt viscosity of the polymer is surprisingly reduced somewhat by the presence of the ester units, and it is often necessary to drive the polymerization to higher molecular weights for the intended processing application than would normally be required for polycaprolactam homopolymer. This is particularly important for those applications where there is a required melt viscosity, such as for films, fibers, or monofilament. This higher molecular weight to achieve the same melt viscosity does result in some strengthening of the product, even to the point where these copolymers can be significantly stronger than nylon-6 itself Another approach to polyesteramides is disclosed in DE 4327024 and EP 0765911 and EP 0561224. Each disclose a method of heating caprolactam, adipic acid and 1,4-butanediol to form polyesteramide. The advantage of this choice is in the costs of raw materials. This combination is the most preferred polyesteramide of this invention, except for those products where a low water transmission rate is necessary. To achieve biodegradability, the products are made with a high ester content, thereby sacrificing strength as a consequence. The better approach, herein described, is to make polyesteramides with lower ester content, thereby gaining advantages in strength, and to achieve a high rate of degradability by other means.

The polyesteramide may also be prepared in the melt phase, particularly for polyesteramides based on AB-type polyamides. The polyamide can be scrambled with ester by melting the polyamide in the presence of diacids(plus diol), lactones, or polylactones, or polyesters, and allowing sufficient time for ester units to be incorporated into the polyamide chains. Adipic, lactic acid or caprolactone units are preferred, either present as blocks or randomly distributed along the polyamide chains, but units of glycolic or hydroxybutyrates are acceptable. The most preferred ester to incorporate through scrambling is caprolactone, because even though the scrambling rate is slower than for lactic units, there is no tendency for caprolactone to decompose during scrambling. In a commercial-scale reactor the product handles normally and does not have any additional color (and is clearer than homopolymer of caprolactam). The copolymers have excellent strength properties and are somewhat more hydrophobic than most other copolymers. Under certain conditions lactic units degrade to impart both a yellowing to the product and to impart an odor to the product. The scrambling can be accomplished by blending in the melt phase the polyamide with, e.g., the dimer or polymer of lactic acid or caprolactone. Lactic acid ester scrambling, for reasons we do not understand, are incorporated into, e.g., nylon 6, backbones at a much higher rate than caprolactone. Any polylactic acid polymer or copolymer may be used for preparing esteramide copolymers, including copolymers of lactic acid with glycolic or caprolactone. D-lactic or L-lactic or D,L-lactic polymers may be used because the melting point of the esteramide copolymer is high enough that melt processing is straightforward. No catalyst is necessary to accomplish modification of the polyamide backbone provided there is at least a ten minute exposure of the polyamide to the polylactide in the melt with good mixing. An alternative pathway is to mix the cyclic dimer of lactic acid with the polyamide and extrude this. Lactic ester units are inserted into the polyamide even in the short residence times available during extrusion. From C¹³ nmr it is clear the lactic unit is not present in a single environment, so at least dimers seem to be present. The nmr pattern is fairly complex and seems to reflect a multifaceted incorporation. The polyamide may be modified or unmodified prior to the blending with other components of the final compositions. The scrambling described herein can be accomplished in an operation prior to preparation of the final blend composition, or all components of the blend can be incorporated in one procedure. It is preferred to make the polyesteramide in a separate operation in order to ensure that the molecular weight of the copolymer is over 20,000 Mw and preferably between 30,000-500,000. This higher Mw is required for the esteramide copolymers to achieve the same melt viscosity as amide homopolymer. This relationship in melt viscosity is completely unanticipated, and has some real advantages in the commercial art. Extractables are lower in these higher molecular weight materials, and it may be possible to eliminate the extraction and drying phases for some products of current commercial practice. This could result in a significant reduction in the process costs.

When ester units are incorporated into the polyamide chain, the melting point is depressed. When 10% caprolactone units are incorporated into a nylon-6 polymer, the melting temperature, for example, drops to nearly 200° C., as compared with 222° C. for the nylon-6 homopolymer. At 20% caprolactone in nylon-6 the melting temperature is around 180° C. This drop in melting point is important for making blends with starch, as starch should not be melt processed above 190° C. Converting the polyamide homopolymer into a polyamide—co-polyester has the important impact of imparting to the plastic the quality of degradability. For products which are intended to be composted, the minimum level of ester to accomplish composting behavior is 10%. At this low level of ester some other material, generally PVOH or EVOH and/or starch, will need to be present in order that the article lose mechanical integrity during the initial phase of composting. Generally the composting qualities are improved as the ester content is raised. Strength decreases at high ester contents, so the preferred range for a given product is a compromise between the qualities of composting rate and strength. For most products the preferred ester range is 5-80%, and most preferred is 20-50%. Degradability of all esteramide copolymers is enhanced by adding vinyl alcohols or starch or other readily degradable materials or prodegradants. What has been discovered herein are ways of enhancing the degradation rates of strong plastics, strong because the amide level in the polyesteramide is pushed as high as possible, while still allowing for the requisite degradation rate.

Bayer has a commercially available polyesteramide BAK 1095 and other closely related art, composed of caprolactam, adipic acid and 1,4-butanediol. The Bayer patents are EP 0765911 and EP 0561224 and DE 4327024. In order to achieve a high rate of degradability, the ester content is high, often 50% or greater. A high ester content achieves degradability at the sacrifice of strength. In the present invention, the focus is on making stronger materials which will degrade even more rapidly. What Bayer has failed to discover are the benefits of especially PVOH for adding strength, EVOH for improved ease of processing, crosslinkers for added strength, and starch and prodegradants in achieving a low-cost, rapidly degrading product, capable of being tailored over a broad range of composition, and permitting such articles as very thin blown films of exceptional strength.

B. Biodegradable Moisture Sensitive Polymers

Some polyhydric polymers like ethylene-vinyl alcohol copolymers are inherently thermoplastic while other polyhydric polymers like polyvinyl alcohol, are not. For instance, polyvinyl alcohol may be melt-processed as a thermoplast only while in the presence of liquid plasticizer. A common plasticizer for this is glycerol or ethylene glycol; the use of these materials is widely known to enable processing. Also, compositions containing polyvinyl alcohol may be processed as a thermoplast when a monomeric polyhydroxylated compound is present therein [see, e.g., U.S. Pat. No. 4,469,837 (Cattaneo) or when the polyvinyl alcohol has been internally plasticized in either a post-polymerization reaction, such as an alkoxylation reaction [see, e.g., U.S. Pat. Nos. 1,971,662 (Schmidt); 2,844,570 (Broderick) and 2,990,398 (Inskip)], or a copolymerization reaction, such as with poly(alkeneoxy)acrylate [see U.S. Pat. Nos. 4,616,648 (Marten) and 4,675,360 (Marten)], or poly(N-vinyl)pyrrolidone or methacrylic-vinyl amide copolymers [U.S. Pat. No. 5,569,710 (LaFleur)]. All of this art relies on the use of a processing aid which would not be considered to be biodegradable, with the arguable exception of the polyvinylpyrrolidone. Processing aids which are biodegradable include stearamide, “Santicizer 8” (a mixture of o- and p-N-ethyl toluene sulfonamide, sold by Monsanto), and the amides derived by treating fats or oils with ammonia or amines. In addition, certain polyhydric polymers like polyvinyl alcohol, biodegrade at a useful rate when subjected to conditions favorable to biodegradation, with the rate of such biodegradation varying depending on the particular polyhydric polymer.

The use of stearamide to allow melt processing of PVOH is found in the application, WO 97/09379, by Giltsoff. The Giltsoff application deals only with PVOH homopolymer for the manufacture of readily water-soluble articles; there are no blends, no polyesteramides. WO 97/09379 does not explore PVOH blends including polyamides, or polyesters or any type of saccharide. In this work it has been discovered that, while any of the above approaches allows the melt-processing of polymer combinations containing PVOH, using stearamide as processing aid and glycerol as a plasticizer is cost-effective, biodegradable and provides adequate performance. A combination of stearamide and glycerol is most preferred for those products containing PVOH. Santicizer 8, available from Monsanto, also serves very well for this purpose. Alternatively, zinc stearate is also very attractive as a stabilizer, and is also biodegradable and serves as lubricant during processing.

Since the physical properties and characteristics of ethylene-vinyl alcohol copolymers (EVOH) vary as a function of the mole percent ethylene content and the molecular weight, those of ordinary skill in the art should choose an EVOH component with an appropriate balance of these physical parameters to provide a composition with desirable physical properties and characteristics. Of course, those of ordinary skill in the art will readily appreciate that it may be desirable to include as the EVOH component a combination of two or more EVOHs having different physical parameters, such as different ethylene contents and/or molecular weights.

Specifically, the EVOH component should have a molar ratio of vinyl alcohol units to alkene units within the range of from about 80:20 to about 50:50. A preferred EVOH should have a molar ratio of vinyl alcohol units to alkene units within the range of from about 73:27 to about 52:48. In addition, the molecular weight of the EVOH component, calculated from the degree of polymerization and the molecular weight of the repeating unit, preferably should be within the range of about 5,000 Mw to about 300,000 Mw, with about 60,000 Mw being most preferred. (The degree of polymerization refers to the number of times the repeating unit occurs within a given polymer. See J. R. Moore and D, E, Kline, Properties and Processing of Polymers, Society of Plastics Engineers, Inc, Prentice Hall, Inc., Englewood Cliffs, New Jersey (1984)). A suitable EVOH for use as a component in the compositions of the present invention may be obtained from E.I. du Pont de Nemours and Company, Delaware, under the tradename “SELAR-OH”, EVAL Company of America (Lisle, Illinois) under the tradename “EVAL”, and Nippon Gohsei (Osaka, Japan) under the name “SOARNOL”.

Compositions formed by mixing certain polyhydric polymers such as polymers and copolymers of vinyl alcohol and vinyl acetate, particularly with elevated ethylene contents, are known to be useful for particular applications. For example, Japanese Patent Publication JP 03-81357 describes a composition having a polyvinyl acetate component whose maximum free hydroxyl content is 50%. Japanese Patent Publication JP 56-109267 describes an adhesive composition formed from a saponified ethylenevinyl acetate copolymer with an ethylene content which is at the very least 65 mole percent and may be up to 99.7 mole percent. In addition, U.S. Pat. No. 4,950,513 (Mehra) describes a laminar article, prepared from a polyolefin blended with a minor portion of a melt blend of a nylon and a polyvinyl alcohol component, in which the different polymers form separate platelet-like layers within the article. There are two preferred uses in this invention: 1) a processing aid for PVOH to allow blends to be melted or to reduce back pressure in the blending equipment, or 2) to impart moisture barrier properties to an article.

PVOH is a preferred second polymer for blending in those situations where swelling of the polymer blend is appropriate for its use, particularly PVOH with a degree of hydrolysis within the range of from about 40% to about 98%, with a range of from about 72% to about 98% being most preferred. The choice of PVOH polymer depends on how sensitive the ultimate plastic should be to the desired degradation conditions, or to put it in another way, the sensitivity of the material to hot or cold water. Preferred for use herein is PVOH with a molecular weight within the range of from about 10,000 to about 50,000, and most preferred is PVOH with a molecular weight of about 15,000-30,000 Mw.

Since the physical properties and characteristics of PVOH vary as a function of the degree of hydrolysis and the molecular weight, those of ordinary skill in the art should choose a PVOH component with an appropriate balance of these physical parameters to provide a composition with desirable physical properties and characteristics. Of course, those of ordinary skill in the art will readily appreciate that it may be desirable to include as the PVOH component a combination of two or more PVOHs having different physical parameters, such as different degrees of hydrolysis and/or molecular weights.

The PVOH component of the compositions of the present invention may be obtained commercially from the du Pont Company, under the tradename “ELVANOL”; Air Products Corp. (Allentown, Pa.), under the tradename “AIRVOL”; Hoechst-Celanese Corporation (Summit, N.J.), under the tradename “MOWIOL”; Kurraray Company Ltd. (Osaka, Japan), under the tradename “POVAL”; and Wacker Chemicals USA, Inc. (New Canaan, Connecticut), under the tradename “POLYVIOL”.

Very strong films are formed through blending a polyesteramide with EVOH or PVOH. The strength of these blends has made it possible to make very thin blown films; films even as thin as 0.1 mil are possible.

Whether included in the uniform, substantially homogeneous blend or as an extender or filler added thereto, starch is advantageously contained in the compositions of the present invention since it (1) is inexpensive especially when compared with the cost of many of the polymers or copolymers useful herein as polymer (A) or polymer (B); (2) is readily biodegradable; (3) may be blended readily with both thermoplastic polymers and non-thermoplastic polymers to form uniform, substantially homogeneous melt blends; and (4) does not disrupt the co-continuous phase morphology which is observed in the compositions of the present invention when cooled and solidified.

A starch component suitable for use herein may be chosen from a native or granular starch, a chemically modified starch (i.e., a starch derivative), gelatinized starch [such as a starch-based material prepared in accordance with U.S. Pat. No. 3,137,592 (Protzman)], as well as destructurized starch (such as destructurized starch prepared in accordance with U.S. Pat. No. 4,673,438 (Wittwer)) or combinations thereof. A preferred approach, providing good fluidity to polymer blends to be used for injection molding, is to prepare the starch component in a separate operation prior to blending with polyesteramide. The starch/PVOH component is prepared by destructurizing the starch by extruding a mixture of starch, 0.10-0.5% (of the starch component) by weight of hydrogen peroxide, ammonium persulfate or sodium persulfate, and PVOH and up to 30% water. The oxidizing agent facilitates fluidity. See JP 09052901 for the melt-processing of simple starch/PVOH blends using this approach. Derivitizing starch with ethylene imine is taught in U.S. Pat. No. 3,846,405. In this reference the final product is treated with hydrogen chloride. For this invention, adding hydrogen chloride is optional.

The starch component may be a native or granular starch selected from the group consisting of potatoes, rice, tapioca, corn, peas, rye, oats, wheat and combinations thereof. Alternatively, the starch may be a starch derivative, which derivative may be selected from, the group consisting of starch esters, starch ethers and combinations thereof. The starch esters suitable for use in the compositions of the present invention may be selected from the group consisting of methyl esters, ethyl esters, propyl esters, butyl esters, propionates, butyrates, and esters of saturated and unsaturated branched and straight-chain organic acids, having from about five to about twelve carbon atoms.

The starch ethers suitable for use in the compositions of the present invention may be selected from the group consisting of alkylethers, hydroxyalkylethers, hydroxyalkylalkylethers, methyl ethers, ethyl ethers, propyl ethers, butyl ethers, hydroxymethyl ethers, hydroxyethyl ethers, hydroxypropyl ethers, hydroxyethyl methylethers, hydroxypropyl methylethers and combinations thereof.

The degree of substitution of these starch derivatives is the average number of hydroxyl groups on each glucopyranosyl unit which are derivatized by substituents [see M. W. Rutenberg and D. Solerak, “Starch Derivatives: Production and Uses” in Starch: Chemistry and Technology, (2d ed. 1964)] may be within the range of from about 0.1 to about 3.0. However, it is preferred that the degree of substitution of the starch derivative is at least about 0-0.8, and more preferred that it is from about 0.8 to about 2.1.

When the starch component is a starch derivative such as a starch ester, like a starch acetate, it is preferred that the starch component has a degree of substitution within the range of from about 0.5 to about 1.5 and more preferred that the range is from about 0.7 to about 1.4, and most preferred that the range is from about 0.8 to about 1.2. Alternatively, when the starch component is a starch derivative such as a starch ester, like a starch propionate, it is preferred that the starch component has a degree of substitution within the range of from about 0.5 to about 1.6, and more preferably within the range of from about 0.7 to about 1.4.

When the starch component of the composition of the present invention is destructurized starch, the starch used to prepare the destructurized starch may be chosen from a native or granular starch, which way be selected from the group consisting of potatoes, rice, tapioca, corr., peas, rye, oats, wheat and combinations thereof; a starch derivative, with a degree of substitution within the range of from about 0.1 to about 3.0; gelatinized starch; and combinations thereof.

The starch component, as noted above, may be a granular or native starch, a starch derivative, gelatinized starch, destructurized starch or combinations thereof. However, when native or granular starch, or any other starch with at least some degree of granular structure is used as the starch component, it is believed that the biodegradation of the starch component, whose rate of biodegradation is typically greater than that of the polyesteramide, will leave a void in the resulting composition, or shaped article manufactured therefrom, thereby creating a greater surface area onto which microorganisms may grow when subjected to conditions favorable for biodegradation.

Suitable for use in the compositions of the present invention are water-soluble and water-swellable celluloses, examples of which include alkylcelluloses like methyl cellulose; hydroxyalkylcelluloses and hydroxyalkylalkylcelluloses like hydroxymethyl cellulose, hydroxyethyl cellulose, hydroxypropyl cellulose, hydroxyethyl methylcellulose, hydroxypropyl methylcellulose and hydroxybutyl methylcellulose; cellulose esters and hydroxyalkylcellulose esters like cellulose acetylphthalate; carboxyalkylcelluloses; carboxyalkylcellulose esters like carboxymethyl cellulose and salts thereof; and combinations thereof.

Starch has been mixed with polyhydric polymers (e.g., polyvinyl alcohol), with certain of such mixtures (e.g., starch-polyvinyl alcohol mixtures) reported to have been extruded into films and is said to be biodegradable. See e.g., U.S. Pat. Nos. 4,!33,784 (Otey) and 4,337,181 (Otey); and International Patent Publication No. WO 93/0917 (Bastioli).

In addition, International Patent Publication No. WO 92/16583 (Dake) refers to biodegradable compositions containing a starch derivative; a polymer, such as polyvinyl alcohol or ethylene-vinyl alcohol copolymers; and a plasticizer. The plasticizer is added to enable the composition to be processed as a thermoplast. Also, International Patent Publication WO 92/14782 (Bastioli) and WO 92/19680 (Bastioli) each refer to starch containing polymer compositions, with plasticizer components added to facilitate processing of the polymer component of the composition.

Japanese Patent Publication JP 04-146047 relates to a composition containing starch and ethylene-vinyl alcohol copolymer, which may include polyvinyl alcohol as a filler. Such use of polyvinyl alcohol is not a thermoplastic one, especially when, as taught in this reference, glycerin is added to the composition as a plasticizer.

According to U.S. Pat. No. 4,673,438 (Wittwer), the disclosure of which is herein incorporated by reference, when starch is heated under shear in the presence of relatively small amounts of water, the resulting new starch-water composition, in the form of a melt, surprisingly has thermoplastic properties. Those thermoplastic starch compositions have become known as “destructurized starch.” See also U.S. Pat. Nos. 4,73B.724 (Wittwer) and 4,900,361 (Sachetto), the disclosures of which are also herein incorporated by reference.

According to U.S. Pat. No. 5,095,054 (Lay), the disclosure of which is herein incorporated by reference, destructurized starch may be combined with certain polymers to form thermoplastic compositions which are useful in the formation of molded articles which exhibit dimensional stability.

An attractive film which is readily biodegradable is composed of mixtures of pectin and polyvinyl alcohol. Pectin is a polysaccharide found in plant cell walls and is readily biodegradable and water soluble. When pectin is mixed with PVOH the blends are more flexible than pectin alone, and stronger than PVOH alone. A shortcoming of this blend is that there is too great a susceptibility to atmospheric moisture, resulting in a lowering of strength properties. But when this blend is mixed with the polyesteramide, the weakness with respect to atmospheric moisture is avoided, the materials, whether film or injection molded, are strengthened. The art prior to this disclosure has missed the strength accorded by a degradable polyamide.

One type of moisture sensitive polymer suitable for use herein are the compositions based on destructurized starch interpenetrating networks (alternatively referred to herein as “starch IPNS”). Thermoplastic, biodegradable compositions based on interpenetrated networks of starch with a synthetic component such as an ethylenevinyl alcohol (EVOH) copolymer are described in U.S. Pat. No. 5,262,458, U.S. Pat. No. 5,409,973, U.S. Pat. No. 5,094,054 and U.S. Pat. No. 5,258,430; and International Patent Application WO 91/02023 and European Patent Application No. 90-8105331. Such materials are available commercially from Novamont under the tradename Mater-Bi, for example, the commercially available material codes AF05H and AF010H. These materials contain greater than 50% starch by weight and are therefore very sensitive to moisture vapor levels in the ambient atmosphere as well as direct contact with liquid water.

Films formed of only the interpenetrated network of starch and a synthetic component can be extruded with very good mechanical properties initially. However, these properties vary considerably with humidity. For example, the modulus of a Mater-Bi film (Type AF05H) decreases by about 50% as the relative humidity changes from about 20% to 90%. Although such sensitivity to humidity is a reversible process, it makes the film inconsistent on a day-to-day basis to the degree that converting operations and use performance are negatively affected.

Mater-Bi films also absorb water to a high degree, typically about 30% of their initial weight. In addition to lowering the strength of the film significantly, the high water absorption also leads to very high moisture transmission through the film. This is beneficial in some applications where breathability is desired. However, high moisture transmission may not be desirable if the film is expected to contain large quantities of fluids, as in the case of a diaper backsheet. High water permeation can lead to excessive condensation on the outside of the backsheet, leaving it cold and wet to the touch.

Another moisture sensitive polymer that may be used herein is hydroxypropyl cellulose (alternatively referred to herein as HPC(s)). HPC is a nonionic cellulose ether with an unusual combination of properties among cellulose derivatives. These include solubility in both water and polar organic solvents as well as plastic flow properties that permit its use for molded and extruded articles such as films. As described in the aforementioned Handbook of Water Soluble Gums- and Resins, Chapter 13, flow properties of HPC enable it to be used as a base material in extrusion, blow, or injection molding, and film-making operations, Thermally processed products formed by these methods retain their water solubilities, are biodegradable, and can even be made to be edible. The chemical cellulose used to prepare HPC is derived from wood pulp or cotton linters. The cellulose is treated with aqueous sodium hydroxide to form alkali cellulose which, in turn, is reacted with propylene oxide. Commercially, HPC is available from Hercules Inc. under the tradename KLUCEL.

C. Polyesters

Thermally sensitive polymers suitable for use herein include certain linear, saturated (i.e., aliphatic) polyesters. Many aliphatic polyesters are known to be biodegradable and compostable. Although some types of thermally sensitive, aliphatic polyesters can be melt processed directly into various products, their melting points or softening points are too low to allow their use alone in many applications. For example, thermally sensitive, aliphatic polyesters are not singularly suitable for forming a monolayer backsheet for disposable absorbent articles.

Other types of thermally sensitive, aliphatic polyesters suitable for use in the compositions of the present invention are those derived from the reaction of an aliphatic dicarboxylic acid and a diol. As described in “An Overview of Plastics Degradability Handbook, Modem Plastics (August 1989); many of these polyesters are biodegradable since they are susceptible to enzymatic hydrolysis. Moreover, the acid and alcohol fragments of the hydrolysis are also easily assimilated by microorganisms. Examples include poly(1,3-propanediol adipate), poly(1,4-butanediol adipate), poly(1,4-butanediol sebacate), poly(1,3-propanediol succinate), and poly(1,4-butanediol glutarate). Further examples of thermally sensitive, aliphatic polyesters can be found in Polymer Handbook, Third Edition, J. Brandrup and E. H. Immergut, John Wiley & Sons (1989b Section VL).

Poly(hydroxyalkanoates) (PHAs) form one class of polymers that are difficult to process by melt methods. PHAs can be synthetically derived from hydroxycarboxylic acids. This class of polymer also includes naturally derived polymers such as polyhydroxybutyrate (PHB), including homopolymers of 3-hydroxybutyrate and 4-hydroxybutyrate. Other PHAs include copolymers of PHB with hydroxy acids, for example, copolymers of PHB with 3-hydroxypropionate, 3-hydroxy valerate, 3-hydroxyhexanoate, 3-hydroxyoctanoate, or longer chain hydroxy acids (e.g. C9-C12 hydroxyacids) and copolymers thereof.

Preferred examples of polyhydroxybutyrate homopolymer and polyhydroxybutyrate/valerate copolymers are described in U.S. Pat. No. 4,393,167, Holmes et al., issued Jul. 12, 1983, and U.S. Pat. No. 4,880,592, Martin, et al., issued Nov. 14, 1989, both references incorporated herein by reference.

Such copolymers are commercially available from Monsanto under the tradename Biopol. The Biopol polymers are produced from the fermentation of sugar by the bacterium Ucagenes eutophus. PHBV polymers have been produced with valerate contents ranging from about 5 to about 95 mol %, and are currently commercially available with valerate contents ranging from about 5 to about 12 mol %. As the valerate content of the polymer increases, the melting point, crystallinity, and stiffness decreases. An overview of Biopol technology is provided in Business 2000+(Winter 1990). Other polymers that are suitable for use herein are described by E. Shimamura, at al., Macromolecules, 1994, 27(3), 878-80. Shimamura at al. describe isotactic homopolymers and copolymers of hydroxyalkanoic acids with four to fourteen carbon atoms having saturated, unsaturated, and aromatic side chains in the 3n hydroxyalkanoic acid monomeric unit. This reference also describes copolymers containing hydroxyalkanoate monomeric units without side chains, such as 3-hydroxypropionate, 4-hydroxy butyrate, and hydroxy valerate. Polyhydroxyalkanoates that are suitable for use herein are also described in International Publication No. WO 94/00506.

Polyhydroxyalkanoates tend to exhibit thermomechanical integrity over the temperatures that may be typically encountered during converting processes of disposable absorbent articles, as previously described in reference to backsheet films. Unfortunately, polyhydroxyalkanoates tend to have low melt strengths and may also suffer from a long set time, such that they tend to be difficult to melt process.

Included also in the polyester class of polymers which can serve as useful additives are the oxidized polyketones. This class of polymers processes quite readily. Polyketones are produced by copolymerizing ethylene with carbon monoxide. Recently Shell introduced polyketones under the tradename of Carilon. Polyketones are not biodegradable without first undergoing at least partial conversion to ester through oxidation. Oxidation converts some ketone units into ester, which makes the polymer susceptible to hydrolytic cleavage.

Other polyesters which are useful as blending materials include those materials such as those polyesteramides disclosed by BASF. These are materials based upon copolymers of adipic acid and terephthalic acid (WO 9621691, WO 9615176, WO 9615175, WO 9615173, WO 9621690 WO 9625446, WO 9621692 and WO 9621689). These materials lack the enhancements of the present invention in strength and degradation rate which are available especially through the addition of PVOH and/or EVOH. DuPont also has invented a biodegradable polyester based upon terephthalic units (WO 9514740, U.S. Pat. No. 5,171,309, U.S. Pat. No. 5,171,308, U.S. Pat. No. 5,0534,82). The Dupont materials are suitable for blending with polyamide esters and are attractive for products where a somewhat lower water transmission rate is needed.

D. Cellulosic Materials

One type of mechanically limited polymer that is suitable for use herein are cellulose esters and plasticized derivatives thereof, cellulose esters are produced by the chemical modification of cellulose and include the family of cellulose acetates, cellulose acetate propionates, and cellulose acetate butyrates (hereinafter alternatively referred to as CA(s), CAP(s), and CAB(s), respectively). As described in Moderm Plastics Encyclopedia, (McGraw-Hill 1990), cellulose esters are prepared by reacting cellulose with particular acids and acid anhydrides, generally in the presence of a sulfuric acid catalyst. In the case of CA, the reaction is first carried out with acetic acid and acetic anhydride to produce cellulose triacetate, which contains nearly 100% acetyl substitution or, in other words, a degree of substitution of about 3.0. The triacetate is then partially hydrolyzed to remove some of the acetyl groups such that the CA product contains about 38 to 50% acetyl substitution.

CAP and CAB are made by substituting propionic acid and propionic anhydride or butyric acid or butyric anhydride for some of the acetic acid and acetic anhydride. Plastic grades of CAP generally contain 39 to 47% propionyl and 2 to 9% acetyl content. Plastic CAB grades generally contain 26 to 39% butyryl and 12 to 15% acetyl content. Commercially, CA, CAB, and CAP are obtained from Eastman Chemical Co., Inc., of Kingsport, Tenn., under the tradename Tenite.

Fully formulated grades of cellulose esters may also contain plasticizer, heat stabilizers, and ultraviolet inhibitors. High levels of these stabilizers and inhibitors may further slow the rate of biodegradation of cellulose esters. Zero or very low levels of such stabilizers are generally preferred in films which are desired to be biodegradable.

Although raw cellulose and its regenerated film (cellophane) and fiber (rayon) forms are readily biodegradable, the esterification of cellulose can make it quite stable to microbial attack as described in Polymer Degradation,, W. Schnabel (Macmillan 1981), this enhanced resistance to biodegradation results from the inability of cellulose-specific enzymes to attack the substituted portions of the polysaccharide. However, as described by Buchanan, Gardner and Komarek, in a paper entitled “The Fate of Cellulose Esters in the Environment—Aerobic Biodegradation of Cellulose Acetate,” J. Applied Polymer, 1709 (1993), the rate of degradation of cellulose esters also depends upon the degree of substitution. In general, the biodegradable cellulose esters herein have a degree of substitution of less than 2.5, preferably less than 2.0. For example, a CA with a 1.7 degree of substitution was found to biodegrade much faster than a CA with a 2.5 degree of substitution. Plasticized CA with a degree of substitution between 1.7 and 2.5 provides a suitable balance between melt processability and biodegradability, and are therefore the preferred cellulose esters for use herein. As reported by J. M. Gu, et al., J, Envron. Polym. Degradation, 1, 143, (1993), CA having a degree of substitution greater than 2.5 were not biodegradable. CA having a degree of substitution less than 1.7 are generally not melt processable, even with the addition of a plasticizer.

Plasticized cellulose esters, such as CA, CAP, and CAB are thermoplastic and can be melt processed into thin films and other products. Unless substantial levels of plasticizer are employed, the stiffness of such films is too high for them to be useful in applications requiring flexibility, such as backsheets for absorbent articles. Even in the presence of plasticizer, the tear propagation resistance of cellulose ester films is too low for such applications.

Some blends of cellulose esters, and plasticized derivatives thereof, with aliphatic polyesters can form another type of mechanically limited polymer that is useful herein. It is well known that cellulose esters form miscible blends with many aliphatic polyesters. U.S. Pat. No. 3,642,507, herein incorporated by reference, discloses the formulation of printing inks with improved flexibility by blending a cellulose ester with polycaprolactone, U.S. Pat. No. 3,922,239, herein incorporated by reference, also discloses the preparation of thermoplastic blends of cellulose esters and polycaprolactone and other cyclic ester polymers. The addition of the polyesters was found to lower the modulus of the blend significantly below that of the cellulose ester and to impart improved melt processability, toughness, and impact resistance.

More recently, blends of CAP and CAB with polyhydroxybutyrate (PHB) have been described in several papers: “Miscibility of Bacterial Poly(3-hydroxy butyrate with Cellulose Esters,” Scandola et al., Macromolecules, 25(24), 6441-6 (1992); “Cellulose Acetate Butyrate and Poly(hydroxy butyrate-w-valerate) Copolymer Blends,” Buchanan et al., Macromolecules, 25(26), 7373 -81 (1992). Experimental evidence of miscibility was found up to 50% PHB. Crystallization of the PHB was found to be strongly inhibited by the presence of cellulose esters confirming intimate mixing of the blend components. Similar results are obtained if PHBV copolymers are employed in place of PHB.

Blends as described above are thermoplastic and may, depending on the specific blend, be processed into thin, flexible films with stiffness levels appropriate for backsheet films. However, the tear propagation resistance, tensile elongation, or thermomechanical integrity of such films alone is still deficient compared to those normally used to construct many products, including absorbent articles such as disposable diapers. In addition, these materials may suffer from relatively long set times, which can make melt-processing difficult.

Another polymer that can be classified as being mechanically limited is polylactide (alternatively referred to herein as PLA(s)). PLA is a semicrystalline polymer having a relatively high melting point ranging from 100 to about 130° C., depending on the degree of crystallinity which in turn depends on the relative amounts of the R(+) and S(−) enantiomers in the polymer. The homopolymer tends to be more useful for fiber and nonwoven applications than for film applications. This is because the polymer, having a glass transition temperature of about 65° C., tends to form films of the polymer which are stiff and brittle. Although these limitations can be reduced by adding a plasticizer, the plasticizer level typically required for a significant influence (at least about 20 weight %) tends to excessively reduce the melt strength of the polymer such that extrusion processing is difficult. In addition, such plasticized films tend to have a greasy feel.

PHS and PHBV copolymers may also be considered to be mechanically limited, since films of the copolymer tend to be brittle. However, the primary limitation associated with these copolymers is the difficulty in forming products of the copolymer by melt processing. Some aliphatic polyester-based polyurethanes may also be considered to be mechanically limited due to a relatively low tensile modulus, e.g., on the order of less than about 70 MPa,

E. Biodegradable Elastomers

As defined herein, a thermoplastic elastomer (alternatively referred to herein as TPE(s)) is a material that combines the processability of a thermoplastic with the functional performance and properties of a conventional thermosetting elastomer as disclosed in Modern Plastics Encyclopedia pp. 122-131 (McGraw Hill 1990). Commercially, there are 6 generic classes of TPES: styrenic block copolymers, polyolefins, elastomeric alloys, thermoplastic polyurethanes, thermoplastic copolyesters, and thermoplastic polyamides. For use in the products of the present invention, the thermoplastic elastomer must be biodegradable. From the aforementioned list of TPEs only a select group of thermoplastic polyurethanes, specifically aliphatic polyester-based polyurethanes, are generally recognized as being biodegradable.

Biodegradable polyurethanes can be prepared from low molecular weight aliphatic polyesters derived from epsilon-caprolactone or the reaction products of a diol-dicarboxylic acid condensation. In general, these low molecular weight polyesters have number average molecular weights of less than 10,000 grams per mole and frequently as low as 1,000 to 2,000 grams per mole. Examples of biodegradable polyester urethanes derived from polyethyleneglycol adipate, poly (1,3-propanediol adipate) and poly (1,4-butanediol adipate) are disclosed in “The Prospects for Biodegradable Plastics,” F. Rodriguez, Chem Tech (July 1971). Aliphatic polyester urethanes suitable for use herein are available from Morton International, under the tradename Morthane. For example, Morthane PNO3-204 and Morthane PN3429-100 have been found suitable for use herein, Morthane PNO3-204 and Morthane PN3429-100 have a number average molecular weight, respectively, of 96,000 grams/mole and 120,000 grams/mole.

An elastic polymer can be formed when the structure is linear block copolymers comprising relatively long blocks in which molecular interactions are weak (soft), interconnected by shorter blocks in which molecular interactions are strong (hard). For example, a polyether is soft and a polyamide is hard.

In general, as the number average molecular weight and the hard/soft segment ratio of the polyurethane decreases, the polymers of the blend containing the polyurethane tend to be more compatible. As the number average molecular weight and the hard/soft segment ratio of the polyurethane increases, the blend containing the polyurethane tends to exhibit better processing, which is believed to be due to an enhancement of the melt strength. The polyurethane may be selected within these guidelines by the skilled artisan to tailor the attributes of the particular urethane as necessary.

Another type of TPE that is suitable for use in the compositions herein are the block copolymers of polycaprolactone with polydienes. Copolymers of this type are disclosed in U.S. Pat. No. 1,581,257 issued to Mueller et al herein incorporated by reference. This patent discloses block copolymers of polycaprolactone with polydienes such as polyisoprene and polybutadiene in which the polycaprolactone content can be varied from about 20 to about 80 weight percent and the diene content varied from about 80 to about 20 weight percent. Copolymers having tensile strengths in the range of between 245 and 200 pounds per square inch and elongations to break in the range from 400 to 560 percent are obtained.

The polycaprolactone/polydiene block copolymers can be prepared having various architectures. For example, an A-B diblock copolymer has a block of polymer A segments coupled to a block of B polymer segments. An A-B-A triblock copolymer has a block of B segments coupled to a block of A segments at each of its terminal ends. Aₙ-(A-B)ₙ- multiblock copolymer has alternating sequences of A and B segments where n is a positive integer greater than 1.

For toughening and increasing the tear strengths of films of the present invention, A-B-A triblock or -(A-B)ₙ- multiblock copolymer in which the A blocks include polycaprolactone, and n is a positive integer greater than 1, are generally preferred. Simple diblock A-B copolymers do not impart significant tear strength improvement to films of the present invention. Especially preferred are triblock copolymers in which the polycaprolactone segments comprise from about 10 to about 60 weight percent of the copolymer and the polydiene segments comprise from about 90 to about 40 weight percent of the copolymer.

Another application for the TPE containing caprolactone and diene is in preparing those articles which can allow for only low swelling when contacted with water or moisture. This includes articles which are molded or blown. Syringes which are intended for single use and end up in the trash would fall into this class. When syringes are stored they are exposed to atmospheric moisture, but the components cannot be allowed to swell in a significant way, for the parts would no longer fit. With equilibrium moisture values as high as 30% in some biodegradable plastics such as Mater-Bi, such materials are clearly unacceptable for syringe use.

Compositions of the Present Invention

The compositions of the present invention are derived from blends of various polymers, selected and combined such that the deficiencies of the individual, polymeric components as previously described are overcome. Thus, the compositions include at least two polymers which lack the limitations previously described.

The compositions contain compatible or semicompatible blends of polymers. As is understood by those skilled in the art, compatible blends typically exhibit synergistic behavior in at least one mechanical property, as compared to the individual polymers in the blend. Other mechanical properties are typically intermediate between those of the individual polymers. Semicompatible polymers typically exhibit mechanical properties that are between those of the individual polymers making up the blend. In contrast, incompatible blends typically exhibit phase separation on a macroscale (i.e., on the order of microns) and at least one mechanical property, generally substantially all mechanical properties which are diminished relative to each of the individual polymers making up the blend. Incompatible blends often have relatively low strengths and low elongations to break.

The compositions of the present invention are thermoplastic and can be melt processed into biodegradable products, such as fibers and films, having physical integrity. Products formed from preferred compositions exhibit thermomechanical integrity and mechanical properties that enable their use in a number of practical applications. For example, certain preferred compositions are suitable for application in disposable articles.

The compositions may be described as comprising one or more of the polyesteramide copolymers. Alternatively, they may be a blend of polyesteramide(s) and one or more polymer selected from the categories of biodegradable elastomers, biodegradable cellulosics, biodegradable polyesters, or biodegradable moisture sensitive polymers.

The presence of a polyesteramide copolymer in a compostable, biodegradable plastic is a key element in providing strength to the final formed products. Polyesteramides further serve to improve stability under normal storage conditions because moisture absorption actually toughens polyamides, moisture serving as a plasticizer. In the articles of the disclosed compositions, the copolymers will mineralize completely because the polyamide chains are altered to insert units which will cause fragmentation of high molecular weight chains into lower molecular weight units.

The polymers of the present composition are appropriately selected so as to tailor the properties of the composition. For some products it is desirable to have the plastic degrade through an initial swelling process in which the article absorbs moisture, causing the article to become significantly larger. The enlarging process disclosed here is caused by moisture migrating to the interior portions of the polymer blend, interacting with the polymers. Especially those compositions containing PVOH, EVOH, or starch will swell in the presence of moisture. The consequent swelling separates the polymer chains in the non-crystalline regions to make room for the water molecules, creating a structure in which there are microchannels into and out of the polymer mass, into which may flow minerals or ions or microbial species which effect the breakdown of the polymer chains. This mechanism is particularly helpful for the breakdown of crystalline polymers having glass transition temperatures above 65° C., or above typical composting temperatures.

When used, a moisture sensitive polymer is typically used in an amount of from about 0% to about 70% by weight of the composition. As the skilled artisan will understand, the moisture sensitivity of the composition tends to increase as the amount of moisture sensitive polymer increases. The amount of moisture sensitive polymer will therefore generally be selected to provide an acceptable moisture resistance, e.g., an acceptable moisture transport rate, for a given application. For golf tees a high level of the moisture sensitive polymer is desirable to ensure rapid breakdown; for diaper backsheet it may be more appropriate to have a low level of the moisture sensitive polymer present.

Preferred moisture sensitive polymers for use in the present invention are PVOH or EVOH or combinations thereof, or starch, or starch IPNS. PVOH and EVOH are particularly useful for imparting good melt processing (by increasing melt strength and reducing set time) and tensile properties which are generally suitable.

The moisture sensitive polymers classified as thermoplastic polyvinyl alcohol compositions and starch IPNs tend to be compatible with the aliphatic polyester-based polyurethanes and polycaprolactone used herein, but incompatible with polylactides, cellulose esters, hydroxypropyl cellulose, and polyhydroxyalkanoates.

Particular embodiments of the preferred compositions of the present invention, which include a polyesteramide, will now be described,

(A) Compositions Based upon Polyesteramide with Possibly Other Minor Components

According to one preferred embodiment of the present invention, the composition includes at least one polyesteramide, especially one based on caprolactam, with ester units provided by adipic acid (plus 1,4-butanediol or 1,6 hexanediol) or lactic acid, or polylactic acid(PLA), or caprolactone or polycaprolactone (PCL). The ratio between caprolactam and these esters can vary with the application requirements. The polyesteramide is prepared according to any of the methods described previously, generally heating and mixing at high temperature for several minutes or hours. For tough products in which the degradation time should be intermediate-, the blend could include 70-90% caprolactam and 30-10% ester. When a product which degrades somewhat faster is required, and the strength does not have to be quite so high, then the blend could include 30-70% caprolactam and 70-30% ester. The mechanical properties of the compositions containing ester can be modified with a plasticizer, as desired, at relatively low plasticizer level, without reducing the melt processability of the composition. Thus, the resultant composition tends to have an acceptable melt strength and does not tend to block unacceptably, and may be modified with a plasticizer as may be necessary to obtain desired mechanical properties. These compositions are particularly suitable for those films, molded articles, monofilament, sheet, thermoformed, or fiber in which an intermediate water transmission rate is allowable.

The polyesteramide copolymer is useful for a variety of applications. A very low-ester (under 10% ester) content polyesteramide analog or nylon-6 or nylon-6/6 makes stronger, clearer films, and may be cheaper than conventional product because it may be possible to eliminate the conventional extraction and drying steps for some applications. These materials would not degrade rapidly and would not conform to definitions of biodegradability because of low-ester content, thus, they may well be attractive substitutes for the polyamides, especially for products where low haze is important, such as film for food packaging. These products, nonetheless, will degrade more rapidly than polyamide homopolymers, but for many applications will possess a service lifetime far exceeding A somewhat higher ester content, generally 10-50% will give a material more readily degradable. Especially for products which should not swell substantially in humid environments, this is the type of material which may be appropriate. Particularly for those products where moisture stability is important, the caprolactam/caprolactone copolymer is generally more preferred than the caprolactam/lactic or caprolactam/adipic acid/butanediol copolymers. These copolymers are useful for making clear, degradable films, for cast or blown film products such as diaper backsheet, garbage bags, shopping sacks, or as a coating for paper, or injection molded into flower pots, pens, razor handles. Degradability can be enhanced, especially by adding pyrophosphates.

An alternate approach to the difficulty of water transmission rates for some problems, particularly diaper backsheet, is disclosed herein. In this option a polymer film having higher water transmission rates can be coated with a hydrophobic coating. The polymer coating need not be biodegradable, though a biodegradable product is preferred. In the most preferred approach, a wax, either a natural wax or a polyethylene wax with molecular weight under 5000, is premixed with the formulation and extruded and converted into a film. It has been discovered that the wax migrates to the film surfaces where it can serve as a barrier to water. The advantage of this approach is that it allows the use of highly degradable polymers, which tend to have high rates of water transmission, and still achieve the “dry” feel of the diaper.

A still higher ester content, generally from 40-80% changes the copolymer to resemble more the polyester itself. On advantage of incorporating some amide units into the ester copolymer is to increase the melt temperature of the polyester and also the melt strength. Amide imparts desirable material and processing qualities.

(B) Compositions Including Polyesteramide and Starch and Vinyl Alcohol

In another preferred embodiment of the present invention, a polyesteramide is used in combination with starch and one or more vinyl alcohol (s). This composition contains from about 10% to about 70% polyesteramide, from about 0% to about 70% starch, and from 5% co about 50% vinyl alcohol, based an the total weight of these polymers in the composition. The vinyl alcohol is normally chosen from EVOH and PVOH, or a combination of the two polymers. EVOH is easier to melt process and under extrusion conditions allows the extruder to operate at lower pressures. PVOH is attractive because it forms such strong materials, especially cast or blown films. If starch or destructurized starch is included, the starch and vinyl alcohol(s) are normally blended in a separate step, then blended with the polyesteramide. Blending the starch and vinyl alcohols separately facilitates swelling or expansion of the starch particles to give a more homogeneous, clearer product. Having a largely dry blend is desirable when this starch/vinyl alcohol product is blended with the polyesteramide, because the degree of hydrolysis of the polyesteramide is thereby limited. The starch may be dried or not, depending on the application, prior to blending with the vinyl alcohols. water can also be added to the starch and vinyl alcohol blending to facilitate starch particle expansion. These compositions tend to provide compatible or semicompatible blends having a suitable combination of thermomechanical integrity, melt processability, and mechanical properties. The blends are intended for those applications in which a rapid rate of degradation is attractive. The polyesteramide provides strength and reduces storage moisture sensitivity, while starch, or destructurized starch, and the vinyl alcohols, provide for rapid swelling of the product, especially in a warm, moist environment, as in composting, resulting in rapid mechanical failure of the product, along with facile biodegradation. A more preferred compositional range contains from about 20% to about 60% polyesteramide, from about 45% to about 0% starch, and from about 40% to about 10% vinyl alcohol (s) based on the total weight of these polymers in the composition. These compositions tend to provide physical properties which are suitable for use in applications where rapid degradation is desirable, where the tensile strength requirements of the product are high, but the water transmission rate does not have to be low.

This blend allows exceptionally thin, strong films ideal for such products as compostable garbage bags or shopping bags. It is also useful as a biodegradable coating for paper. It also makes strong monofilament, suitable for fabricating into matting for reducing erosion along highway construction. This combination is also useful for making compostable packing chips. To a high starch-vinyl alcohol blend, the presence of polyesteramide imparts a degree of moisture desensitization, giving the product a better shelf-life than products without polyesteramide. Yet another example of an appropriate application is in use for disposable cutlery. This product is used one time, and discarded. It is desirable to have a product which will lose its mechanical properties quickly enough to be composted. To one skilled in the art, addition of fillers, such as talc, and a plasticizer would be considered natural additions to impart stiffness, or softness, or to reduce overall costs. For forming films, it may be desired to include a plasticizer in the composition in order to lower the modulus of the film. Another use of a plastic with high starch levels is in making golf tees. For a product such as golf tees, which should disappear from sight in a matter of 1-2 days when left on the ground, a very rapid rate of decay is required. This may be achieved through a combination of a small amount of polyesteramide and a large portion of polyvinyl alcohol (EVOH and/or PVOH) and a starch and/or fillers. The fillers, which range from 30-90% of the total weight of the composition,include sawdust or limestone.

A typical golf tee could be prepared with 5% polyesteramide (50% ester and 50% amide), 5% PVOH, 1% crosslinker and 89% sawdust.

(C) Compositions—Including a Polyesteramide and an Aliphatic Polyester-based Polyurethane or Oxidized Polyketone

In an alternatively preferred embodiment of the present invention, the composition includes at least one polyesteramide and at least one aliphatic, polyester-based polyurethane, or oxidized polyketone, or terephthalate/aliphatic copolyesters such as offered by DuPont. For forming films, the composition preferably includes from about 20% to about 80% polyesteramide and, respectively, from about 80% to about 20% of one or more members of these classes, based on the total weight of these polymers. When these materials are blended with the polyesteramide, reduced moisture transmission rates are seen, a quality important for an article such as diaper backsheet. This composition tends to provide compatible blends having a suitable combination of thermomechanical integrity, melt processability, and mechanical properties. This combination is also suitable for injection molded pieces. A virtue of this combination is its relatively low moisture transmission rate and equilibrium water content, which limits swelling. More preferably, the composition contains from about 20% to about 60% polyesteramide and, respectively, from 80% to about 40% polyurethane or oxidized polyketone, based on the total weight of these polymers. This combination is particularly suitable for films for making diaper backsheets and other hygiene products. It is also preferred for molded articles which must have a low equilibrium water content, such as disposable syringes. The choice of urethane and/or oxidized polyketone is based in part on strength requirements, the polyketone being stronger, and in part upon the fate in the environment.

The alternative for syringes is to have a biodegradable plastic and to coat the interior surface of the barrel with a hydrophobic coating, such as those described for diaper backsheet. Also the barrel of the syringe could be made of a readily biodegradable plastic coated with a hydrophobic material. The coating approach is preferred since in drug delivery it is important that the syringe does not adsorb the drug onto the surfaces of the syringe. A hydrophobic coating, bearing few functional, polar groups, has a lesser probability of adsorption than a highly polar polymer. A convenient approach to coating the surfaces is to extrude a blend of biodegradable resin(s) mixed with a polyethylene wax; the wax will be incompatible and migrate to the surfaces.

(D) Embodiment Wherein Additional Modifier is a Naturally Occurring Biodegradable Material

According to one embodiment of the present invention, the composition contains a polyesteramide, with or without vinyl alcohol, with or without starch. It may be desirable to add other naturally occurring materials to impart desirable qualities to the blend. Cellulosics, or derivatized cellulosics such as offered by Eastman, are one such material; chitin is another. To one skilled in the art it is clear there are many natural products, which may be modified prior to use in these applications, are attractive for specific applications.

(E) Other Compositions of the Present Invention

The present invention also encompasses compositions derived from other blends of polymers. These compositions tend to provide compatible or semicompatible blends having good thermomechanical integrity, mechanical properties, and/or melt processability. The compositions can include two or more biodegradable polymers to provide binary blends, ternary blends, etc. Such blends may be used to form products, such as films, fibers and nonwovens, monofilament, and molded pieces which are useful in a variety of applications.

It has been found that polyesteramide can compatibilize a mixture including cellulose ester, hydroxypropyl cellulose, or polyhydroxyalkanoate. This compatibilization can occur when the combined amount of polyesteramide exceeds the amount cellulose ester, hydroxypropyl cellulose, and polyhydroxyalkanoate. Other materials, such as degradable polyurethanes, or polyketones can be added to this blend to provide a compatible or semicompatible blend.

In general, plasticizers are more efficient at reducing the stiffness than an elastomer. However, plasticizers usually also reduces the tensile strength whereas the aforementioned polymers typically increase the strength. The skilled artisan is able to select appropriate levels of such polymers and plasticizers in light of the teachings herein to achieve a desired balance between flexibility and strength. For example, the composition may include from about 20 to about 80 weight percent polyesteramide and from about 80 to about 20 weight percent of an elastomer, based on the total weight of the biodegradable polymers present in the composition.

Hydrolytically cleavable polyesters are typically used in compositions containing more rapidly biodegradable polymers selected from moisture sensitive polymers, thermally sensitive polymers, polymers difficult to melt process, and mixtures thereof. Blending with such other polymers tends to enhance the initial breakup and ultimate degradation of the polyester polymers. When used, aromatic/aliphatic polyester copolymers typically make up from about 60 weight percent to about 95 weight percent of the blend, based on the total weight of the biodegradable polymers present in the composition. Oxidized ECO copolymers are useful in the compositions of the present invention to impart heat resistance and moisture resistance, and can be employed in amounts ranging from 1 to 99 weight percent of the total weight of the polymers in the composition. Shell's CARILON ECO is an example of a useful starting material. Some portion of the ketone backbones can be converted to ester by oxidation. This renders the chains hydrolytically active at the ester sites. High melting aliphatic polyesters may be used in blends with other biodegradable polymers wherein the high melting aliphatic polyester makes up from about 1 to about 99 weight percent of the total weight of the polymers in the composition.

When used in the compositions of the present invention, a biodegradable elastomer tends to lower the tensile modulus and to increase the ultimate elongation, tear strength, impact strength, and moisture resistance relative to the composition. The elastomer is typically used in an amount of from about 10% to about 80%, preferably from about 20% to about 80%, of the total weight of the polymers in the composition. It is expected that certain compositions including an aliphatic polyester-based polyurethane, which compositions are described below, exhibit synergistic toughening. The tensile strength of extruded products of these compositions tends to exceed that of the individual components of the composition.

In those preferred compositions which include an aliphatic polyester-based polyurethane, it is generally preferred to maintain the level of polyurethane in the composition to less than about 80 weight %, based on the total weight of the polymers in the composition. At higher levels of polyurethane, films formed from the composition tend to-be too soft, e.g., the tensile modulus tends to fall below about 10,000 psi. In addition, the composition tends to lack sufficient thermomechanical integrity for use in film such as diaper backsheet, where a plasticizer is included in the preferred compositions.

Optional Components

In addition to the above-mentioned components, the compositions of the present invention may contain other components as may be, or later become, known in the art, including, but not limited to, plasticizer, antiblocking agents, antistatic agents, slip agents, pro-heat stabilizers, antioxidants, promoxidant additives, pigments, etc. Antiblocking agents, antistatic agents and slip agents are typically employed in compositions to be used for forming films. Pro-heat stabilizers, antioxidants and promoxidant additives are typically employed in compositions to be melt processed.

Plasticizers may be used in the composition to modify the mechanical properties of products formed from the composition. In general, plasticizer tends to lower the modulus and tensile strength, and to increase the ultimate elongation, impact strength, and tear strength of the polymeric product. The plasticizer may also be used to lower the melting point of the composition to thereby enable melt processing at lower temperatures and to minimize energy requirements and thermal degradation. The use of a plasticizer may therefore be particularly useful in compositions containing high melting polymers, e.g., polyamides.

Several plasticizing compounds are known in the art and are suitable for use herein. Suitable plasticizer are exemplified by glycerol triacetate, methyl picolinate, dihexyl phthalate, low molecular weight polycaprolactone diol or polycaprolactone triol (typically having number average molecular weights of less than about 1000 grams per mole), acetyltri-n-butyl citrate, and others such as those described in the above referenced U.S. Pat. Nos. 3,182,036 and 5,231,148.

Antiblocking agents act to prevent film layers from sticking to one another when wound into a roll or when disposable articles are packaged in contact with one another. Typical antiblocking substances include concentrates of silica or talc blended with a polymeric material such as polyethylene or polycaprolactone. Reduction of blocking in the films of the present invention can also be obtained by loading the film surface with small particles or powders such as chalk, clay, silica, starch, and similar materials. Powdered polymeric materials (e.g., polytetrafluoroethylene) can also be used to reduce blocking when applied to the surface of films of the present invention. Such film surface treatments can be used to reduce blocking alone or in combination with other antiblock methods. The quantity of powder antiblock substance commonly added to the surface of a film, when used, is from about 0.5 g/m² to about 5 g/m².

Antistatic agents may be incorporated in films of the present invention: examples of such agents include ethoxylated amines and quaternary amino salts having organic constituents of about 12-18 carbon atoms in length. Agents of this type slowly defuse to the surface of the film and, because of their ionic character, form an electrically conductive layer on the surface of the film. Antistatic agents commonly constitute from about 1% to about 5% of the weight of the films, when used.

Slip agents may be incorporated into the films of the present invention to reduce drag over rollers and other forming equipment. Examples of such agents are those commonly derived from amides of fatty adds having about 12-22 carbon atoms. Such agents may augment the antiblocking properties of the films of the present invention. Such slip agents are commonly incorporated in films from about 0.05% to about 3% of the weight of the film.

Applications

The compositions of the present invention can be melt processed into several forms, including films, fibers, nonwovens, monofilament, bottles and other containers, and other shaped articles.

The compositions of the present invention are particularly suitable for use in blown film products such as garbage bags and shopping bags. The combination of polyesteramide and PVOH enables the formation of very thin films, thereby reducing the cost of the products. A PVOH can be chosen which is insoluble in cold water but soluble in hot water, which reduces the possibility of the film absorbing moisture and expanding prematurely. The specific choice of PVOH product is dependent upon the other materials present in the intended product, and the use conditions of the product. The ideal PVOH product can be selected by making prototypes and determining how they perform under use conditions. Films should be stable under use conditions, but respond to the temperature and moisture conditions available during composting. Products destined for hot, high-humidity climates may need a different blend than one intended for a cool, dry climate.

It has been found that films which are sufficiently strong to be suitable as biodegradable backsheets or disposable articles demonstrate two properties: (a) resistance to tearing (tear propagation resistance or tear strength) in both the machine direction and the cross-machine direction of manufacture, and (b) resistance to rupture from a dropped weight (i.e., impact strength).

The compositions of the present invention are also suitable for forming films such as are known in the art, including continuous films, apertured films, including hydroformed films and vacuum formed films, and the like. The films may be processed using conventional procedures for producing films of blended polymers on conventional film making equipment. The present compositions are particularly well-suited for processing by melt extrusion methods.

Monofilaments can be made using conventional equipment. The temperature for extruding the present polymeric composition is lower than what would be used for conventional nylon-6. Monofilaments can be used for netting, erosion matting, fishing line, and grass trimmer cord. For erosion matting, PVOH is helpful in causing the product to swell during use, thus providing an enhanced barrier to prevent soil loss; for fishing line no PVOH is generally required because the article is intended to be used for several months; for grass trimmer cord, the presence of PVOH is useful not only to enhance the strength, but also to cause the product to degrade and disappear from the lawn.

The amount of PVOH incorporated into the polymeric composition depends on the ultimate end use of the composition; for instance, no PVOH should be incorporated into fishing line, whereas in grass trimmer cord, the PVOH concentration is preferably 10-40 wt % and in erosion matting, the PVOH concentration is preferably from 20 to 50 wt %.

Standard injection molding techniques and equipment can be used for articles such as containers, bottles, golf tees, pens, or cutlery. It may be desirable to add a nucleating agent to the polymer blend to shorten crystallization times and facilitate high production rates. Standard fillers may be added to improve properties and/or reduce cost.

In general, melt extrusion methods involve blending of the above described polymeric components followed by extrusion of the blend. Pellets of the polymeric components can be first dry blended and then melt mixed in the extruder itself. Alternatively, if insufficient mixing occurs in the extruder, the pellets can be first dry blended and then melt mixed in a pre-compounding extruder followed by repelletization prior to film extrusion.

Melt extrusion methods suitable for forming articles of the present invention include cast or blown film extrusion methods, both of which are described in Plastics Extrusion Technology, 2nd Ed., Allan A, Griff (Van Nostrand Reinhold, 1976).

In blown film extrusion (also referred to as tubular film extrusion), the molten blend is extruded upward through a thin annular die opening to form a tube. Air is introduced through the center of the die to inflate the tube thereby causing it to expand. A moving bubble is thus formed which is held at constant size by control of internal air pressure. The tube of film is cooled by air blown through one or more chill rings surrounding the tube. The tube is next collapsed by drawing it into a flattening frame through a pair of pull rolls and into a winder. For backsheet applications the flattened tubular film is subsequently slit open, unfolded, and further slit into widths appropriate for use in absorbent articles.

Both cast film and blown film processes can be used to produce either monolayer or multilayer film structures. For the production of monolayer films from a single thermoplastic material or blend of thermoplastic components only a single extruder and single manifold die are required.

Injection molded pieces can be made on normal equipment. For compostable cutlery, standard injection molding machines can be employed. For a degradable food plate, the normal plastics processing equipment may be used. For blow molded parts, such as shampoo bottles, or other household products, standard operations are suitable. Using polymers of the invention is not advised for aggressive materials such as bleach, ammonia, vinegar, toilet bowl cleaner, or acids, or bases or oxidants, or fuels.

The polymeric compositions herein can be processed into fibers by methods such as are known in the art for example, melt spinning and melt blowing. Processes for forming nonwovens from fibrous materials are also well known. For example, the nonwoven may be spunbonded, melt blown, air-laid, carded, hydroentangled, combinations of the forementioned, and negative impact on its physical integrity or mechanical properties. Since articles may experience temperatures as high as 140° F. (60° C.) during warehouse storage or shipping in trucks or railcars, or even as high as 195° F. (90° C.) or more during converting operations, it is important that the plastic retain its integrity at these temperatures. Although it is expected that the properties of the article decrease somewhat as the temperature increases from room temperature to such elevated temperatures, the properties should not decrease too far.

For reactive spinning, reactive film, or reactive molding, a prepolymer or other crosslinker is injected into a stream of molten, thermoplastic polymer such as, for example, polyurethane polymer, immediately prior to the spin pack, the ring for blown film, or the die for cast film or molding. The crosslinker, which is typically an isocyanate capped prepolymer, may react with urethane units to form allophanates.

Allophanates are formed from the addition of two moles of isocyanate to 1 mole of alcohol as follows.

RNCO+R′OH=RNHCO2R′(urethane)+RNCO=RNHCONRCO2R′(allophanate)

The polyesteramide composition of the present invention can be cured after the processing step by the addition of dual UV-curable and moisture curable silicone conformal compositions.

The radiation and moisture-curable silicone composition which may suitably comprise:

a silicone fluid comprised of a monovalent ethylenically unsaturated functional group endcapped silicone, said endcapped silicone being the product of a reaction between a silanol terminated silicone and a silane cross linker having joined directly to a silicon atom thereof a monovalent ethylenically unsaturated functional group and at least 2 hydrolyzable groups; and at least one (meth)acryl-functionalized silicone; and a photoinitiator effective for radiation curing of the silicone composition.

The silanol terminated silicone preferably comprises a linear polydiorganosiloxane having a viscosity as measured on a Brooksfield viscometer at ambient temperature (about 25.degree. C.) of less than or equal to about 1000 cps, preferably less than or equal to about 750 cps and most preferably of less than or equal to about 200 cps.

The silanol-terminated silicone preferably is predominantly linear in character, having the silanol (—SiOH) functionality located at the terminus of a polysiloxy (—(SiO)ₓ—) moiety in the silicone molecule.

The silane cross-linker which reacts with the silanol endcapped silicone in the above-described composition may advantageously have the formula

RₐSiX_{b}

wherein each R is independently selected from the group consisting of monovalent ethylenically unsaturated radicals, hydrogen, C₁-C₈ alkyl, C₆-C₁₂ aryl, C₇-C₁₈ arylalkyl, and C₇-C₁₈ alkylaryl; X is a monovalent functionality imparting moisture-curability to the reaction product of the silanol-functionalized silicone and silane cross-linker; a has a value of 1 or 2; b has a value of 2 or 3; and a+b=4; with the proviso that when a is 1, R is a monovalent ethylenically unsaturated radical, and that when a is 2, at least one R is a monovalent ethylenically unsaturated radical.

Thus, R may suitably be a monovalent ethylenically unsaturated radical for example selected from the group consisting of vinyl, propenyl, butenyl, pentenyl, hexenyl, octenyl, allyl, alkenyloxy, alkenylamino, allyloxy and allylamino, groups. Specific illustrative species of the crosslinker include vinyltrimethoxysilane, vinyltriaminosilane, vinyltriamidosilane, vinyltrioximinosilane, vinyltriisopropenyloxysilane, and vinyltriacetoxysilane.

A detailed description of the preparation of the UV and moisture curable siloxanes can be found in Chu et al U.S. Pat. No. 5,516,812, the entire disclosure of which is herein incorporated by reference.

The present invention also relates to hollow plastic microspheres or small or large spheres and a process and apparatus for making the microspheres and small spheres with partially or fully oriented polymer in the skin.

The shell of the spheres can be made of polyethylene, polypropylene, polylactic acid, or the compostable and/or degradeable polymer composition defined herein. Preferably, the shell of the spheres are made of the compostable and/or degradeable polymer composition defined herein

In the normal operation, some orientation of the polymer skin is desirable. In this case, the (micro)sphere will be generated in one area, then the particle will travel to an apparatus at lower pressure than the generating area. The (micro)sphere expands, and provided the temperature is between Tg and m.p., the molecules of the polymer become oriented.

The microspheres can be made from a low heat conductivity plastic composition and can contain a low heat conductivity gas. The microspheres can also be made of a thermoplastic with a high melting point for use in a thermoplastic with a lower melting point.

An example of the utility of the microspheres is in the preparation of float lines for fishing nets. The microspheres would be prepared of a polymer having a high melting point, which would retain its integrity when incorporated into a matrix with a lower melting point. Ideally the Tg of the microspheres would be higher than the Tm of the matrix. When float lines of traditional foamed materials are used at great ocean depths (e.g., >300 meters), the float lines lose much of their bouyancy because the cells are invaded by the water. A more pressure resistant foam could be made by incorporating microspheres of the present invention into a matrix.

The microspheres may also be used as plasticizers. Currently, there is a need to replace PVC, where phthalates are used. The microspheres, especially if made of a rubbery product like EPDM could impart softness without the problems associated with VOCs.

The plastic microspheres of the present invention can be used to form a heat barrier by using them to fill void spaces between existing walls or other spaces and by forming them into sheets or other shaped forms to be used as insulation barriers. When used to form insulation barriers, the interstices between the microspheres can be filled with a low heat conductivity gas, a foam or other material all of which increase the heat insulation characteristics of the materials made from the microspheres.

In one embodiment of the invention, the microspheres or small spheres are coated with an adhesive or foam filler, or by blending microspheres/small spheres with a lower-melting polymer and extruded as a sheet or injection molded.

The microspheres can be made from plastic compositions selected for their desired physical and chemical properties. For bulk applications such as insulation, a polyolefin generally represents the best balance of cost and properties and are ideal when the fate of the plastic will be incineration or long-term storage in a landfill; however, when the packing chips are to be composted, the compostable/biodegradable polymer of the present invention is best.

The process and apparatus of the present invention provide a practical and economical means by which hollow plastic microspheres or small spheres having a high heat insulation efficiency can be utilized to prepare a relatively low-cost, efficient insulating material for common every day uses. The present invention represents an improvement over the Torobin processes, supra, by expanding the particles to make them both stronger and of lower density.

The present invention also allows the use of a wide variety of blowing fluids and/or blowing gases or liquids. In accordance with the present invention, a wide variety of fluids can be encapsulated. Since the materials are introduced into the particles above room temperature, the introduced fluids may become solid upon cooling.

The apparatus and process of the present invention provide for the production of hollow plastic microspheres or small or large spheres at economic prices and in large quantities. The process and apparatus of the present invention allows the production of hollow plastic microspheres or small spheres having predetermined diameters, wall thicknesses, strength and resistance to chemical agents and weathering and gas permeability such that superior systems can be designed, manufactured and tailor made to suit a particular desired use. Particles with much thinner walls than demonstrated by Torobin are possible.

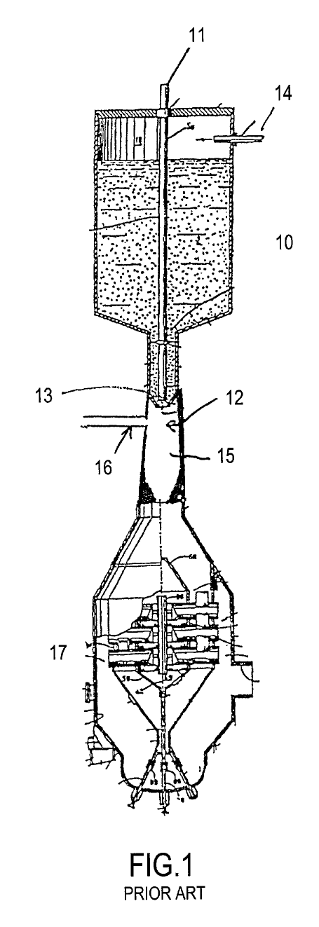

An apparatus for generating microspheres, and expanding them immediately is shown in FIG. 1 and is essentially equivalent to the apparatus taught in Dehne U.S. Pat. No. 5,536,287. Vessel 10, which is similar to that taught by Torobin, supra, is an optionfor the generation of hollow spheres. -Vessel 10 contains the thermoplastic resin in the melt form. A gas (or liquid) is forced through pipe 11 which extends longitudinally from a central position in the top of the vessel to a point in close proximity to opening 12 in the bottom of vessel 10. The viscosity of the resin melt, the size of opening 12 and the pressure applied to the upper surface of the polymer melt by the gas introduced through an inlet pipe 14, are chosen to control the release of the polymer melt through opening 12 while giving the polymer melt the freedom of motion to form a film across the opening 13 at the bottom of pipe 11. The pressure of the gas (or liquid) is applied in a pulsing fashion through pipe 11, and blows the film forming an elongated cylinder-shaped liquid film of plastic which is closed at its outer end into chamber 15. A transverse jet may or may not be used through inlet 16, to direct an entraining gas at an angle to the axis of the opening 12. The entraining gas as it passes over and around the elongated cylinder fluid dynamically induces a pulsating or fluctuating pressure field at the opposite side of the opening 12. The fluctuating pressure field has regular periodic oscillations similar to those of a flag flapping in a breeze. The transverse jet entraining gas can also be pulsed at regular intervals to assist in controlling: a) the size of the microspheres; b) the separation of the microspheres from the opening 12; and c) the distance or spacing between microspheres. The entraining gas envelops and acts asymmetrically on the elongated cylinder and causes the cylinder to flap, fold, pinch and close-off at its inner end at a point proximate to the opening 12. The continued movement of the entraining fluid over the elongated cylinder produces asymmetric fluid drag forces on the cylinder and closes and detaches the elongated cylinder from the coaxial blowing nozzle to have it fall from the blowing nozzle. The surface tension forces of the plastic act on the entrained elongated cylinder and cause the cylinder to seek a minimum surface area and to form a spherical shape.

The temperature in chamber 15 is maintained at a level which is between the Tg and the m.p. of the polymer and the pressure is generally maintained at a higher level than that in collector assembly 17. The expansion of the microspheres aids in the isotropic orientation of the polymer molecules in the spherical shell.

As in the processes of Torobin, the size of the microspheres can be controlled by the rate of pulsing of the transverse jet through inlet 16 into chamber 15 across the opening 12.

The thermoplastic skin can be oriented by delivering the initial product directly to an apparatus for the expansion such as the collector assembly 17, or collected and even stored for later expansion.

The microspheres are generated into a chamber which leads to a collector assembly 17. The collector assembly 17 is essentially a compartment at a lower pressure than the chamber 15, and is maintained at a temperature between the Tg and the m.p. of the thermoplastic. The expanded and isotropically oriented particles are collected. The specific collector shown in FIG. 1 is from U.S. Pat. No. 5,536,287, but in principle many types of apparatus could be used. The apparatus of FIG. 1 is particularly effective for microspheres under 5 microns.

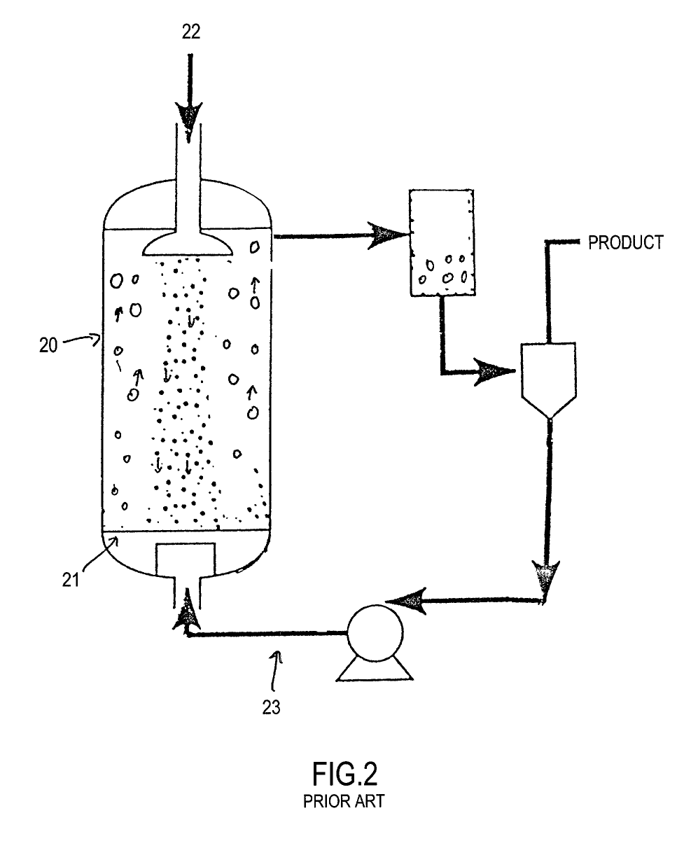

An alternative collector is shown in FIG. 2. The collector comprises a vessel 20 which contains a fluidized bed. This collector is especially good for large microspheres, or for both small and large spheres. Microspheres, small spheres, or large spheres are introduced above the bottom plate 21 of the fluidized bed through inlet 22. A gas stream flowing from tube 23 passes through holes in bottom plate 21. The upward flowing gas stream keeps the spheres suspended. The temperature inside the fluidized bed is between the Tg and the m.p. of the thermoplastic, and the pressure is below the pressure under which the introduced product was generated. As the particles expand, they rise higher in the fluidized bed. When the particles have reached the takeoff level, they are removed and collected.

An alternative approach to preparing microspheres or spheres in large quantities consists of a surface with many holes, similar to a bushing. A polymer film, in the melt phase, is applied to the surface by a blade or wiper while a gas pressure is applied from the opposite side of the surface, blowing a bubble of polymer. The size of the spheres can vary and depend on the size of the holes. Holes can vary between 1 micron to 1 cm.

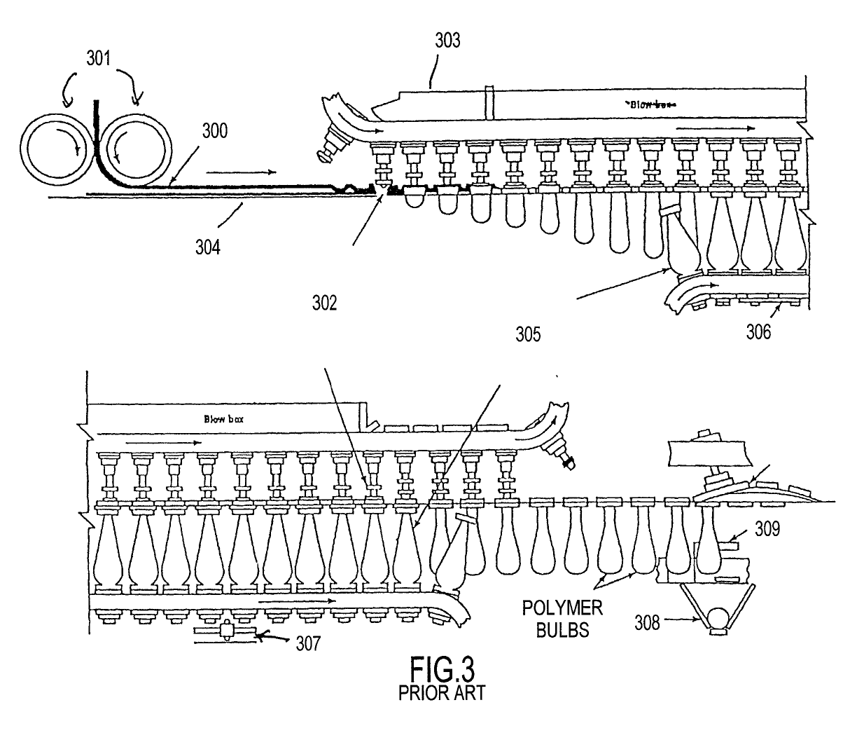

Glass bulbs for light bulbs or Christmas tree ornaments are made on a “ribbon machine” as shown in FIG. 3. The drawing of FIG. 3 is taken from Kirk-Othmer Encyclopedia of Chemical Technology, 4^{th} Edition, volume 12, pg 604. This apparatus is designed to use glass as the feed material, but it can be altered to use thermoplastic, which essentially means running the process at much, lower temperatures. The top portion of FIG. 3 depicts how the glass melt is formed into the bulb geometry and the bottom portion of FIG. 3 depicts the separation of individual glass bulbs from the molds. Initially, a glass ribbon 300 is formed by passing molten glass through water-cooled rollers 301. The glass ribbon 300 is passed on a conveyor means 304 having holes through which the glass is blown by a gas originating from a blow box 303 and ejected through the blow heads 302. The glass bubble is forced into the bulb shape by the action of rotating paste molds 305. The rotating paste molds 305 enclose, by the action of a mold closing cam 306, around a major portion of the forming glass bulb and move in a parallel fashion and at equivalent speed to the blow heads 302. The alignment is such that the rotating paste molds 305 encloses around a major portion of the forming glass bubble. Once the glass bulb has been formed into the appropriate shape, the rotating paste molds 305 are opened by the action of a mold opening cam 307, and the glass bulbs are conveyed to a detaching section wherein a crack-off bar 309 acts to remove the glass bulb from the conveyer means 304, and then is transported away by ware conveyer 308.

If unsealed bulbs of thermoplastic are desired, for example for “packing chips”, the apparatus can be used largely as designed, but at temperatures suitable for plastic. If the bulbs are to be sealed, this is conveniently accomplished by modifying the detaching section of the line so that the neck is pinched shut before the temperature of the thermoplastic has dropped below the m.p.

With increasing concern for the environment has come the recognition that volatile organic compounds (VOCs) from coating paper is a problem. Coatings are often made in the conventional practice by coating from a solution or emulsion and then passing the coated paper through dryers. The production of microspheres makes it possible to apply a coating VOC-free. The microspheres do not need a solvent to be free-flowing, therefore, they can be used directly. Use of microspheres not only eliminates the need for solvent, but also removes the requirement of dryers. The microspheres will generally be melted onto the surface of the paper. The use of microspheres is also an advantage in that they permit the use of thermoplastics not used currently; an example of this is in the area of the nylons. Nylon-1 and nylon-12 are used as coatings, but nylon-6 and nylon-66 are not used because of the high melt viscosity of these polymers. Because the microspheres are applied as powders, then melted, the viscosity problem is avoided.

The microspheres are free-flowing and can be applied using conventional processes used for emulsions or solutions or melts such as: air-knife, inverted blade, knife over roll, unsupported knife, puddle coating, blade coating, wire-bound rod coating, roll coating, gravure coating. They may also be applied using conventional powder coating technology such as: fluidized-bed coating, electrostatic fluidized-bed coating, or electrostatic spray coating.

The microspheres or spheres may be adhered together with known adhesives or binders to produce semi- or rigid cellular type materials for use in manufacturing various products or in construction. The microspheres, because they can be made from very stable plastic compositions, are not subject to degradation by outgassing, aging, moisture, weathering or biological attack. The hollow plastic microspheres when used in manufacture of improved insulating materials can advantageously be used alone or in combination with fiberglass, styrofoam, polyurethane foam, organic and inorganic binders.

In carrying out the process of the present invention, the plastic material to be used to form the microspheres or spheres is selected and can be treated and/or mixed with other materials to adjust their viscosity and surface tension characteristics such that at the desired blowing temperatures they are capable of forming hollow microspheres or spheres of the desired size and wall thickness.

The following examples illustrate the practice of the present invention but are not intended to be limiting thereof.

### Sample Preparation

BAK404-004 and BAK402-005 are polyesteramides prepared from either nylon 6 or nylon 66 and an aliphatic diol (1,4-butanediol) and were obtained from Bayer. Caprolactam-caprolactone copolymer was prepared at Shakespeare. Starches and flour were obtained from manufacturers. The PVOH is AIRVOL 205 from Air Products. Whenever PVOH or starch (or flour) is used in the formulation, 5% stearamide is added as a stabilizer and 5% glycerol(based on PVOH +starch/flour) is added as a plasticizer. Stearamide and glycerol are not required components because the extrusion temperatures (generally 180° C.) were low enough that the PVOH was stable, but they were added to enhance the appearance and softness of the samples as well as reduce extruder back-pressures. Polyesteramide and other components were premixed prior to extrusion.

Break strength was determined by clamping a length of strand from the extruder between two parallel supports which were one inch apart. A chain attached to a container was connected to the center of the strand between the supports. Weight was added to the container until the strand broke. The reported break strength was the average of five tests.

Samples of strand were placed in an outdoor environment in the Fall in the state of Pennsylvania, USA in contact with the ground. The site was protected from rodents. If the sample disappeared in six weeks (ave soil temperature of 57° F.) it was said to rapidly biodegrade, if by twelve weeks (ave. soil temperature was 57° F. for first six weeks, then 51° F. for next six weeks) it is moderate, and if it took up to months for the sample to disappear (57° F. or 6 weeks, 51° F. for 6 weeks, then 37° F. for 4 months, and 50 OF for 3 months) then it was designated as slow.

### EXAMPLES 1-8

### Polyesteramide and Blends with Other Additives

Polyesteramide was made by heating a mixture of caprolactam, adipic acid and 1,4-hexanediol in the molar amounts indicated by Table 1 to a temperature of 240° C., and then vacuum stripping for 1 hr, then cooling and pulverizing. The final blends were prepared by taking the appropriate weight percentage of the pellets from the preliminary blends, combining these, mixing thoroughly, extruding at 180° C. Strands were tested directly for break strength.

The starch was CLINTON® 106 Corn Starch from Archer Daniels Midland. This is a high-amylopectin starch. It was used as received. The PVOH is AIRVOL 205 from Air Products.

What is evident from Table 1 is that as the caprolactam content decreases, so does the break strength.

TABLE 1
POLYESTERANIDE AND BLENDS WITH OTHER ADDITIVES

| | | Adipic/ | | | | Break |
|---|---|---|---|---|---|---|
| Example | Caprolactam | Diol | EVOH | PVOH | Starch | (lb) |
| 1 | 80 | 20 | 0 | 0 | 0 | >20 |
| 2 | 60 | 40 | 0 | 0 | 0 | >20 |
| 3 | 20 | 80 | 0 | 0 | 0 | 8 |
| 4 | 40 | 10 | 40 | 10 | 0 | >20 |
| 5 | 20 | 10 | 20 | 50 | 0 | 15 |
| 6 | 30 | 20 | 10 | 20 | 20 | 18 |
| 7 | 15 | 10 | 10 | 10 | 55 | 4 |
| 8 | 2 | 4 | 0 | 0 | 92 | 1 |

### EXAMPLES 9-20

### Polyesteramide and Starch

BAK404-004 from Bayer is a known biodegradable polyesteramide. The PVOH is AIRVOL 205 from Air Products. The starch was HYLON VII® Food Grade starch (70% amylose) from National Starch. It was used as received or was derivatized by first drying the starch at 80 C in a vacuum for 24 hr, then adding 2% (by wt) 3-aminopropyltrimethoxysilane, 1% (by wt) of 0.5 N hydrochloric acid, mixing, then warming slowly in an oven to 100° C., and pulling a vacuum (5mm) for 1 hr, and cooling.

The data of Table 2 demonstrate improved strengths with derivatized starch.

TABLE 2
BAK404-004 and starch

| Example | BAK404-004 | PVOH | Hylon VII | Der. Hylon VII | Break |
|---|---|---|---|---|---|
| 9 | 30 | 20 | 50 | 0 | 4 |
| 10 | 30 | 0 | 80 | 0 | 1 |
| 11 | 50 | 10 | 40 | 0 | 8 |
| 12 | 50 | 0 | 50 | 0 | 6 |
| 13 | 70 | 10 | 20 | 0 | >20 |
| 14 | 70 | 0 | 30 | 0 | >20 |
| 15 | 30 | 20 | 0 | 50 | 6 |
| 16 | 30 | 0 | 0 | 80 | 2 |
| 17 | 50 | 10 | 0 | 40 | 13 |
| 18 | 50 | 0 | 0 | 50 | 9 |
| 19 | 70 | 10 | 0 | 20 | >20 |
| 20 | 70 | 0 | 0 | 30 | >20 |

### EXAMPLES 21-32

### Polyesteramide and Starch

BAK402-005 from Bayer is a known biodegradable polyesteramide. The PVOH is AIRVOL 205 from Air Products. The starch was derivatized prior to extrusion by drying the starch under vacuum, then combining 4% (by weight) of aziridine in a reactor with the starch, warming to 120° C. and gently stirring (without solvent) for 10 hr, then vacuum drying and cooling and adding 8% water (by weight).

The data in Table 3 demonstrate improved strength by functionalizing the starch with an amine crosslinking group.

TABLE 3
BAK402-005 and starch

| Example | BAK402-005 | PVOH | Hylon VII | Der. Hylon VII | Break |
|---|---|---|---|---|---|
| 21 | 30 | 20 | 50 | 0 | 2 |
| 22 | 30 | 0 | 80 | 0 | 1 |
| 23 | 50 | 10 | 40 | 0 | 7 |
| 24 | 50 | 0 | 50 | 0 | 5 |
| 25 | 70 | 10 | 20 | 0 | >20 |
| 26 | 70 | 0 | 30 | 0 | 18 |
| 27 | 30 | 20 | 0 | 50 | 6 |
| 28 | 30 | 0 | 0 | 80 | 4 |
| 29 | 50 | 10 | 0 | 40 | 13 |
| 30 | 50 | 0 | 0 | 50 | 7 |
| 31 | 70 | 10 | 0 | 20 | >20 |
| 32 | 70 | 0 | 0 | 30 | >20 |

### EXAMPLES 33-38

### Post-process Crosslinker

Caprolactam (98%)-caprolactone(2%) copolymer (Mw 60,000) was one sample of polyesteramide. BAK404-004 or BAX402-005 (both from Bayer) were also used.

The HYLON VII® starch was dried in a vacuum oven. Vinyltrimethoxysilane was used in the final formulation at the 2.0 weight percent level. This was added as a post-process crosslinker (crosslinked with radiation curing and moisture).

The mixes were extruded at 180° C.

TABLE 4
Post-Process Crosslinker

| Sample | Polyesteramide | Hylon VII | Break |
|---|---|---|---|
| 33 | A, 80 | 20 | >20 |
| 34 | A, 20 | 80 | 3 |
| 35 | B, 80 | 20 | >20 |
| 36 | B, 20 | 80 | 3 |
| 37 | C, 80 | 20 | >20 |
| 38 | C, 20 | 80 | 3 |

A = Caprolactam-caprolactone
B = BAK404-004
C = BAK402-005

### EXAMPLES 39-46

### Various Starches and Flour

BAK402-005 was mixed with various starches and flour and extruded. The results demonstrate that a variety of materials may be used to make strong samples.

The mixes were extruded at 180° C.

TABLE 5
Various Starches and Flour

| Example | BAK402-005 | Starch | Flour | Break |
|---|---|---|---|---|
| 39 | 70 | 30 | 0 | >20 |
| 40 | 70 | 30 | 0 | >20 |
| 41 | 70 | 0 | 30 | >20 |
| 42 | 70 | 30 | 0 | >20 |
| 43 | 50 | 50 | 0 | 8 |
| 44 | 50 | 50 | 0 | 7 |
| 45 | 50 | 0 | 50 | 9 |
| 46 | 50 | 50 | 0 | 9 |

39 & 44: MELOJEL ®, National Starch
40 & 46: AMIOCA ®, National Starch
41 & 45: Comet Rice Flour
42 & 43: HYLON VII ®, National Starch

### EXAMPLES 47-50

### Crosslinking Polyesteramide for Strength

The polyesteramide is made by heating a mixture of caprolactam, adipic acid and trimellitic acid in the molar amounts indicated by the table. 1,4-Butanediol was added in a molar amount equal to the adipic acid. Heating to a temperature of 240° C., vacuum stripping for 3 hr, was followed by cooling and pulverizing. The molar ratio of adipic acid (di-acid) to trimellitic acid (tri-acid) was either 9:1 or 50:1. The powders were mixed 50 parts of polyesteramide and 50 parts of HYLON VII® derivatized with 5% (by wt) aziridine.

The data in Table 6 demonstrate a novel approach to crosslinking a starch to free acid sites in the polyesteramide.

TABLE 6
Crosslinking Polyesteramide for Strength

| Example | Caprolact. | Total acid/diol | Ratio Di/Tri Acid | Break |
|---|---|---|---|---|
| 47 | 70 | 15 | 9:1 | >20 |
| 48 | 20 | 65 | 9:1 | 7 |
| 49 | 70 | 15 | 50:1 | 18 |
| 50 | 20 | 65 | 50:1 | 4 |

### EXAMPLES 51-56

### Crosslinking with Triamines for Strength

The polyesteramide is made by heating a mixture of caprolactam, adipic acid, Jeffamine T 403, and 1,4-butanediol to a temperature of 240° C. The molar proportions of caprolactam and adipic acid are shown in the second and third columns of Table 7. The moles of functional groups of Jeffamine and 1,4-butanediol equal the moles of functional groups of adipic acid. The ratio of 1,4-butanediol to Jeffamine is shown in the third column. With the temperature at 240° C. the melt is vacuum stripped for 4 hr, cooled and pulverizing. The starch was HYLON VII derivatized with 1% (by wt) epichlorohydrin.

The data in Table 7 demonstrate that one approach to crosslinking is to incorporate a free site into the polyesteramide backbone.

TABLE 7
CROSSLINKING WITH TRIAMINES FOR STRENGTH

| Example | Capro./Adipic | Ratio diol/triamine | Starch | Break |
|---|---|---|---|---|
| 51 | 5/1 | 9:1 | 0 | >20 |
| 52 | 1/1 | 9:1 | 0 | >20 |
| 53 | 1/5 | 9:1 | 50 | 10 |
| 54 | 5/1 | 50:1 | 0 | >20 |
| 55 | 1/1 | 50:1 | 0 | 6 |
| 56 | 1/5 | 50:1 | 50 | 3 |

### EXAMPLES 57-64

### Processing Aids for Incorporating PVOH and Starch

The polyesteramide is made by heating a mixture of caprolactam, adipic acid and 1,4-hexanediol in the molar amounts indicated by the table to a temperature of 240° C., and then vacuum stripping for 1 hr, cooling and pulverizing. In a separate blending operation, EVOH and/or PVOH and/or starch and a processing aid for the PVOH are combined and extruded. The PVOH is AIRVOL 205 from Air Products, starch is “Clinton 106 Corn Starch” from ADM. The final blends are prepared by taking appropriate amounts of the pellets from each component.

The data in Table 8 demonstrate that polyesteramides and PVOH are expected to melt process with non-polymeric processing aids.

TABLE 8
PROCESSING AIDS FOR INCORPORATING PVOH AND STARCH

| Ex- | Capro- | Adipic/ | | | Gly- | Process- | Aid- |
|---|---|---|---|---|---|---|---|
| ample | lactam | Diol | PVOH | Starch | cerol | ing | Type |
| 57 | 70 | 10 | 10 | 0 | 5 | 5 | a |
| 58 | 20 | 60 | 10 | 0 | 5 | 5 | a |
| 59 | 30 | 20 | 20 | 20 | 5 | 5 | a |
| 60 | 15 | 10 | 10 | 55 | 5 | 5 | a |
| 61 | 70 | 10 | 10 | 0 | 5 | 5 | b |
| 62 | 20 | 60 | 10 | 0 | 5 | 5 | b |
| 63 | 30 | 20 | 20 | 20 | 5 | 5 | b |
| 64 | 15 | 10 | 10 | 55 | 5 | 5 | b |

a = Santicizer 8
b = Polyvinylpyrolidone

### EXAMPLES 65-72

### Copolymer Based upon Nylon-6/6

Terephthalic acid and hexamethylenediamine are combined with 1,6-hexanediol and a molar amount of adipic acid equal to the molar sum of the diamine and diol minus the molar amount of terephthalic acid and heated slowly with agitation, in an autoclave under 25 psi pressure, while taking off water, to 240°C. The pressure is released and vacuum is gradually applied. The temperature is taken to 270° C. under vacuum with a slight nitrogen purge. The batch is withdrawn from the reactor, cooled and ground. This product is pelletized, then combined with materials as in Examples 1-8 and extruded and formed into film and injection molded parts. The starch was derivatized with ethyleneimine at the weight percent level. The zinc pyrophosphate is added during the final extrusion of the pellets.

What is seen in Table 9 is a demonstration that a copolymer based upon nylon-6/6 is expected to be degradable, and that there is expected to be a trend in which both strength and degradability are enhanced by including PVOH or EVCH, and that starch is expected to enhance the rate of degradation.

TABLE 9
COPOLYMER BASED UPON NYLON-6/6^{a}

| Ex. | % Diamine | % Diol | EVOH | PVOH | Starch | TA^{b} | ZP^{c} |
|---|---|---|---|---|---|---|---|
| 65 | 75 | 20 | 0 | 0 | 0 | 0 | 5 |
| 66 | 45 | 40 | 0 | 0 | 0 | 10 | 5 |
| 67 | 15 | 70 | 0 | 0 | 0 | 10 | 5 |
| 68 | 40 | 10 | 25 | 10 | 0 | 10 | 5 |
| 69 | 20 | 10 | 10 | 35 | 10 | 10 | 5 |
| 70 | 30 | 20 | 0 | 15 | 20 | 10 | 5 |
| 71 | 15 | 7.5 | 5 | 10 | 57.5 | 0 | 5 |
| 72 | 20 | 20 | 0 | 0 | 0 | 55 | 5 |

a = all values in the table are molar fractions
b = TA is terephthalic acid
c = ZP is zinc pyrophosphate

Erosion Prevention and Protective Netting

For control of erosion along highway construction, a matting is often required which can prevent erosion on fairly steep slopes. For this type of application a matting with considerable strength, yet rapid degradation, is needed. In another application, netting of the present invention is placed over fruit trees co prevent from eating the nearly ripened crop. Conventional nettings are often prepared of polyolefin and therefore do not degrade resulting in the additional labor costs associated with removal of the net and the inevitable damage to the trees. Netting for these applications is provided by extruding monofilament or multifilament, composed of a polyesteramide with 50-80% ester content, or more preferably being a blend of polyesteramide plus 40-70% PVOH, and/or starch and 0.2-0.5% weight percent crosslinker. The relatively high level of crosslinker imparts strength to the monofilament or multifilament, while not adversely overly affecting the degradation rate. The PVOH and starch will allow the monofilament to take up moisture and expand once the net has been applied. From a cost standpoint, it is advantageous to use more starch than PVOH. This expansion of the monofilament or multifilament will make the matting even more effective in preventing soil loss. Monofilament is then woven into a matting with mesh sizes between 1-6″ openings, knot-to-knot. A single knot construction provides sufficient integrity to the matting for its use application. Multifilament is fabricated into matting on a “knotless” machine.

### EXAMPLE 73

### Preparation of Matting

1387 g (9.5 mol) of adipic acid, 105 g (0.5 mol) trimellitic acid, 900 g (10 mol) of 1,4-butanediol and 2000 9 (17.7 mol) of caprolactam were combined and slowly heated to 170 C in an autoclave. After three hours the pressure is released and water is distilled off. The mixture is heated to 220° C. and a vacuum is applied. The temperature is gradually increased to 240° C. and the polymerization is continued for 4 hours under vacuum at this temperature. The product is cooled and pelletized.

1000 g of PVOH (AIRVOL 205 from Air Products), 25 g of zinc stearamide, 1200 9 of glycerol, 100 g of talc, 600 g of water and 4000 g of raw starch (“Clinton 106 Corn Starch” from ADM) were blended thoroughly and extruded in zones 130-150° C. with no water being removed via venting. The product was pelletized.

3800 g of the polyesteramide pellets, 5000 g of the starch blend, 40 g of epichlorohydrin or sodium trimetaphosphate, and 20 g of zinc oxide were thoroughly mixed and extruded into multifilament. The multifilament was converted into matting on a “knotless” machine.

The following table lists compositional product ranges for biodegradable products.

Rate of Degredation

| Com- | Film or Fiber | | | Thermoformed or Molded | | |
|---|---|---|---|---|---|---|
| ponent | Rapid | Moderate | Slow | Rapid | Moderate | Slow |
| Poly- | 5-40% | 41-70% | 71-95% | 2-20% | 21-40% | 41-90% |
| esteramide | | | | | | |
| 20-40% | | X | X | | X | X |
| ester | | | | | | |
| 41-60% | X | X | | X | X | |
| ester | | | | | | |
| 61-95% | X | | | X | | |
| ester | | | | | | |
| PVOH/ | 0-60% | 0-30% | 0-10% | 31-60% | 21-30% | 0-20% |
| EVOH | | | | | | |
| Filler | 41-95% | 21-40% | 0-20% | 61-95% | 21-60% | 0-20% |
| Up to 2% | X | X | X | X | X | X |
| Cross- | | | | | | |
| linker | | | | | | |

Notes:
1) Starch is normally dried to 1% water before the crosslinker is added.
2) An aminosiloxane or ethyleneimine are preferred crosslinkers.
3) The filler is as defined in specification.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims. All references cited supra are herein incorporated by reference.

1. A compostable and/or degradable polymer composition, comprising:
polymer (A) which is a polyesteramide copolymer;
polymer (B) which is at least one polymer selected from the group consisting of polyethylenevinyl alcohol, polyvinyl alcohol, polyester, starch, starch derivative, cellulose, polyethylene glycol, chitin, amylose, amylopectin, starch derivatized with ethyleneimine, cellulose derivatized with ethyleneimine, polysaccharides derivatized with ethyleneimine, lignin derivatized with ethyleneimine, farinaceous materials derivatized with ethyleneimine and mixtures thereof;
component (C) which is a plasticizer; and
component (D) which is a crosslinking agent;
wherein the polymer composition comprises 0 to 60 wt % of polymer (B), 0 to 25 wt % of component (C), and 0 to 5 wt % of component (D);
wherein all wt % values are based upon the total weight of the polymer composition; and
with the proviso that the polymer composition must contain at least one of polymer (B) and component (D).

2. The compostable and/or degradable polymer composition according to claim 1, wherein the amide content is 80 to 20 wt % of the polyesteramide copolymer.

3. The compostable and/or degradable polymer composition according to claim 1, wherein the ester content is 20 to 80 wt % of the polyesteramide copolymer.

4. The compostable and/or degradable polymer composition according to claim 1, wherein polymer (A) is prepared from at least one of the following sets of reactants:
i) cyclic amide, dicarboxylic acid or ester and aliphatic diol;
ii) aliphatic polyamide and a cyclic ester, a diol or both;
iii) aliphatic diamine, dicarboxylic acid or ester and aliphatic diol;
iv) cyclic amide, dicarboxylic acid or ester, tricarboylic acid or ester, and aliphatic diol;
v) cyclic amide and cyclic ester;
vi) aminocarboxylic acid, dicarboxylic acid or ester and aliphatic diol;
vii) aliphatic diamine and/or triamine, aliphatic diol, dicarboxylic acid or ester and cyclic amide;
viii) aliphatic polyamide and polyester;
ix) polymerized vegetable oil and polyester, aliphatic diol or both;
x) aliphatic diamine and aliphatic diol;
xi) cyclic amide, aminocarboxylic acid, and hydroxycarboxylic acid;
xii) cyclic amide and hydroxycarboxylic acid;
xiii) aliphatic polyamide and hydroxycarboxylic acid;
xiv) cyclic amide, cyclic ester, dicarboxylic acid or ester and aliphatic diol;
xv) a triol/diol/aliphatic dicarboxylic acid crosspolymer and a polyamide; and
xvi) triol, diol, aliphatic dicarboxylic acid and a cyclic amide.

5. The compostable and/or degradable polymer composition according to claim 4, wherein polymer (A) is prepared from caprolactam and caprolactone.

6. The compostable and/or degradable polymer composition according to claim 4, wherein polymer (A) is prepared from caprolactam and lactic acid.

7. The compostable and/or degradable polymer composition according to claim 4, wherein polymer (A) is prepared from caprolactam, adipic acid, and 1,4-butanediol.

8. The compostable and/or degradable polymer composition according to claim 4, wherein polymer (A) is prepared from hexamethylenediamine, adipic acid, and 1,4-butanediol.

9. The compostable and/or degradable polymer composition according to claim 4, wherein polymer (A) is prepared from polymerized vegetable oil and polyester, aliphatic diol or both.

10. The compostable and/or degradable polymer composition according to claim 4, wherein the cyclic amide is caprolactam, the cyclic ester is caprolactone, the dicarboxylic acid or ester is dimethylterephthalate and the aliphatic diol is selected from the group consisting of ethylene glycol and 1,4-butanediol.

11. The compostable and/or degradable polymer composition according to claim 4, wherein polymer (A) is prepared from the scrambling of a glycerol/diethylene glycol/adipic acid crosspolymer with nylon-6.

12. The compostable and/or degradable polymer composition according to claim 4, wherein polymer (A) is prepared from glycerol, diethylene glycol, adipic acid and caprolactam.

13. The compostable and/or degradable polymer composition according to claim 10, wherein caprolactam is 20-90 wt %, caprolactone is 0-40 wt %; dimethylterephthalate is 5-40 wt %, and ethylene glycol is 5-40 wt %.

14. The compostable and/or degradable polymer composition according to claim 4, wherein the dicarboxylic acid is selected from Formula I:
HOOC—(CH₂)ₙ—COOH (I)
where n is a whole number ranging from 2 to 6.

15. The compostable and/or degradable polymer composition according to claim 4, wherein the aliphatic diol is selected from Formula II:
HO—(CH₂)ₙ—OH (II)
where n is a whole number ranging from 2 to 6.

16. The compostable and/or degradable polymer composition according to claim 4, wherein the cyclic amide is caprolactam.

17. The compostable and/or degradable polymer composition according to claim 4, wherein the aliphatic polyamide is selected from the group consisting of nylon-66 and polycaprolactam.

18. The compostable and/or degradable polymer composition according to claim 4, wherein the cyclic ester is selected from the group consisting of caprolactone and 3,6-dimethyl-1,4-dioxane-2,5-dione.

19. The compostable and/or degradable polymer composition according to claim 4, wherein the aliphatic diamine is selected from Formula III:
H₂N—(CH₂)ₙ—NH₂ (III)
where n is a whole number ranging from 2 to 6.

20. The compostable and/or degradable polymer composition according to claim 4, wherein the aminocarboxylic acid is selected from Formula IV:
H₂N—(CH₂)ₙ—COOH (IV)
where n is a whole number ranging from 2 to 6.

21. The compostable and/or degradable polymer composition according to claim 4, wherein the hydroxycarboxylic acid is selected from Formula V:
HO—(CR₂)ₙ—COOH (V)
where n is a whole number ranging from 2 to 6 and R is selected from the group consisting of hydrogen, methyl and ethyl.

22. The compostable and/or degradable polymer composition according to claim 4, wherein the polyester is selected from the group consisting of polycaprolactone and polylactic acid.

23. The compostable and/or degradable polymer composition according to claim 1, further comprising a polyketone, polyurethane, polylactic acid, starch, polyethylene glycol or mixtures thereof.

24. The compostable and/or degradable polymer composition according to claim 1, wherein polymer (B) is a polyester selected from the group consisting of polylactic acid, polyhydroxyalkanoate, polyhydroxybutyrate, polyhydroxy-valerate, Biopol, polycaprolactone, polyethylene adipate, polyethylene succinate, polybutylene succinate, polyglycolic acid and copolymers and combinations thereof.

25. The compostable and/or degradable polymer composition according to claim 1, which includes polymer (A), polymer (B), and component (D).

26. The compostable and/or degradable polymer composition according to claim 25, wherein polymer (A) is a caprolactam/caprolactone copolymer or a caprolactam/lactic acid copolymer, polymer (B) is PVOH or EVOH.

27. The compostable and/or degradable polymer composition according to claim 1, further comprising a degrading aid.

28. The compostable and/or degradable polymer composition according to claim 27, wherein the degrading aid is selected from the group consisting of ammonium polyphosphate and zinc pyrophosphate.

29. The compostable and/or degradable polymer composition according to claim 27, wherein the degrading aid is in a range of 0.1-5 wt %.

30. The compostable and/or degradable polymer composition according to claim 1, further comprising component (D) which is a crosslinking agent.

31. The compostable and/or degradable polymer composition according to claim 30, wherein the crosslinking agent is selected from the group consisting of a triamine, triol, jeffamine, polyethyleneimine, multifunctional amines, glycerol, sorbitol, EVOH, PVOH, triaminopyrimidines, tetraazacyclo-tetradecane, tricarboxylic acid or ester, tetracarboxylic acid or ester, methylene bis(4-phenyl isocyanate), vinyltrimethoxysilane, diethylene glycol diglycidyl ether, epichlorohydrin, 1,1,3,3,5,5,7,7,9,9,11,11-dodecamethyl-1,11-bis(4-(oxiranylmethoxy)phenyl)-Hexasiloxane, 3-(trimethoxysilyl)-1-Propanamine, zinc pyrophosphate, zinc oxide and mixtures thereof.

32. The compostable and/or degradable polymer composition according to claim 30, wherein the crosslinking agent is selected from the group consisting of
3,3-dimethoxy-7,9-dimethyl-7-((nonamethyltetrasiloxanyl)oxy))-9-((trimethylsilyl)oxy)-2,8,13-trioxa-3,7,9-trisilapentadecan-15-ol;
1,1,1,3,3,5,5,7,7,9,11,13,15,17,19,19, 19-heptadecamethyl-9,11,13,15,17-pentakis(2-(7-oxabicyclo(4.1.0)hept-3-yl)ethyl)-decasiloxane;
poly(oxy(1,1,3,3,5,5,7,7-octamethyl-1,7-tetrasiloxanediyl)oxy-1,3-phenylene(phenylimino)(1,1′-biphenyl)-4,4′-diyl(phenylimino)-1,3-phenylene);
1,1,3,3,5,5,7,7-octamethyl-1,7-tetrasiloxanediol diacetate;
alpha-(nonamethyltetrasiloxanyl)-omega-((trimethylsilyl)oxy)-poly(oxy(((diethylamino)oxy)methylsilylene));
dodecamethyl pentasiloxane;
alpha-(nonamethyltetrasiloxanyl)-omega((trimethylsilyl)oxy)-poly(oxy(((diethylamino)oxy)methylsilylene));
1,1,3,3,5,5,7,7,9,9-decamethyl-1,9-pentasiloxanediol;
1,1,3,3,5,5,7,7,9,9-decamethyl-1,9-bis(4-(oxiranylmethoxy)phenyl)-pentasiloxane;
1,1,3,3,5,5,7,7,9,9,11,11-dodecamethyl-1,11-bis(4-(oxiranylmethoxy)phenyl)-hexasiloxane;
1,1,3,3,5,5,7,7,9,9,11,11,13,13,15,15-hexadecamethyl-1,15-bis(4-(oxiranylmethoxy)phenyl)-octasiloxane;
1,1,3,3,5,5,7,7,9,9,11,11,13,13,15,15,17,17-octadecamethyl-1,17-bis(4-(oxiranylmethoxy)phenyl)-nonasiloxane;
1,1,3,3,5,5,7,7,9,9,11,11,13,13,15,15,17,17,19,19,21,21,23,23-tetracosamethyl-1,23-bis(4-(oxiranylmethoxy)phenyl)dodecasiloxane;
4,4′-(1,1,3,3,5,5,7,7,9,9-decamethyl-1,9-pentasiloxanediyl)bis-phenol;
4,4′-(1,1,3,3,5,5,7,7,9,9,11,11-dodecamethyl-1,11-hexasiloxanediyl)bis-phenol;
4,4′-(1,1,3,3,5,5,7,7,9,9,11,11,13,13,15,15-hexadecamethyl-1,15-octasiloxanediyl)bis-phenol;
4,4′-(1,1,3,3,5,5,7,7,9,9,11,11,13,13,15,15,17,17-octadecamethyl-1,17-nonasiloxanediyl)bis-phenol;
4,4′-(1,1,3,3,5,5,7,7,9,9,11,11,13,13,15,15,17,17,19,19,21,21,23,23-tetracosamethyl-1,23-dodecasiloxanediyl)bis-phenol;
1,1,3,3,5,5,7,7-octamethyl-1,7,-tetrasiloxanediol;
1-ethenyl-1,3,3,5,5,7,7-heptamethyl-1,7-tetrasiloxanediol;
1,1,3,3,5,5-hexamethyl-7,7-diphenyl-1,7-tetrasiloxanediol;
1,1,3,3,5,5,7-heptamethyl-7-(3,3,3-trifluoropropyl)-1,7-tetrasiloxanediol;
1,1,3,3,5,5,7-heptamethyl-7-phenyl-1,7-tetrasiloxanediol;
N,N′-(1,1,3,3,5,5,7,7,9,9,11,11-dodecamethyl-1,11-hexasiloxanediyl)di-3,1-propanediyl)bis(N-(oxiranylmethyl)-oxiranemethanamine;
1,1,3,3,5,5,7,7,9,9,11,11,13,13,15,15,17,17,19,19-eicosamethyl-1,19-bis(4-(methyl-1-(4-oxiranylmethoxy)phenyl)ethyl)phenoxy)-decasiloxane; and
1,1,3,3,5,5-hexamethyl-1,5-bis(4-(1-methyl-1-(4-(oxiranylmethoxy)phenyl)ethyl)phenoxy)-trisiloxane.

33. The compostable and/or degradable polymer composition according to claim 31, wherein the crosslinking agent is selected from the group consisting of zinc pyrophosphate, zinc oxide and mixtures thereof.

34. The compostable and/or degradable polymer composition according to claim 30, wherein the crosslinking agent is incorporated at a level of 0.0 to 2.0 wt percent.

35. The compostable and/or degradable polymer composition according to claim 1, further comprising component (E) which is a polymer end-capped with functional groups.

36. The compostable and/or degradable polymer composition according to claim 35, wherein component (E) is selected from the group consisting of polyether diol, polysilylalcohol, polyesteramidepolyols, polyurethanepolyols, hydroxylated acrylate resins, polyester diols, aminopropyl-terminated polyethylene glycol, aminopropyl-terminated polypropylene glycol, end-capped methacrylate functionalized polyethyleneglycol and epichlorohydrin derivatized polyethylene glycol.

37. The compostable and/or degradable polymer composition according to claim 35, wherein the polyether diol is selected from the group consisting of polyethylene glycol, polyethylene ether glycol, polypropylene ether glycol, polytetramethylene ether glycol, polyhexamethylene ether glycol.

38. The compostable and/or degradable polymer composition according to claim 35, wherein component (E) has a molecular weight of 600 to 4000 dalton.

39. The compostable and/or degradable polymer composition, according to claim 1, having a spherulitic form wherein the spherulites average particle diameter ranges from 100-500 μm.

40. The compostable and/or degradable polymer composition, according to claim 1, where in polymer (B) is in a range of 1 to 60 wt % of the total composition and is selected from the group consisting of starch, starch derivative, cellulose, chitin, amylose, amylopectin and mixtures thereof.

41. The compostable and/or degradable polymer composition according to claim 1, wherein polymer (A) is prepared from caprolactam and caprolactone and polymer (B) is polyvinyl alcohol.

42. The compostable and/or degradable polymer composition according to claim 1, wherein the plasticizer component (C) is selected from the group consisting of polyethylene glycol, polypropylene glycol, polyethylene propylene glycol, glycerol, butenediol, propylene glycol, sorbitol, glycerol triacetate, methyl ricinolate, dihexyl phthalate, low molecular weight polycaprolactone diol or triol, acetyl-tri-n-butyl citrate, and combinations thereof.

43. A method for preparing a compostable and/or degradable polymer composition, comprising combining polymer (A) which is a polyesteramide copolymer with at least one of polymer (B) and component (D);
wherein polymer (B) which is at least one polymer selected from the group consisting of polyethylenevinyl alcohol, polyvinyl alcohol, polyester, starch, starch derivative, cellulose, polyethylene glycol, chitin, amylose, amylopectin, starch derivatized with ethyleneimine, cellulose derivatized with ethyleneimine, polysaccharides derivatized with ethyleneimine, lignin derivatized with ethyleneimine, farinaceous materials derivatized with ethyleneimine and mixtures thereof;
component (D) which is a crosslinking agent;
in an amount necessary to have up to 60 wt % of polymer (B) and up to 5 wt % of component (D);
wherein all wt % values are based upon the total weight of the polymer composition.

44. The method for preparing a compostable and/or degradable polymer composition according to claim 43, further comprising the step of preparing polymer (A) by combining at least one of the following sets of reactants:
i) cyclic amide, dicarboxylic acid or ester and aliphatic diol;
ii) aliphatic polyamide and a cyclic ester, a diol or both;
iii) aliphatic diamine, dicarboxylic acid or ester and aliphatic diol;
iv) cyclic amide, dicarboxylic acid or ester, tricarboylic acid or ester, and aliphatic diol;
v) cyclic amide and cyclic ester;
vi) aminocarboxylic acid, dicarboxylic acid or ester and aliphatic diol;
vii) aliphatic diamine and/or triamine, aliphatic diol, dicarboxylic acid or ester and cyclic amide;
viii) aliphatic polyamide and polyester;
ix) polymerized vegetable oil and polyester, aliphatic diol or both;
x) aliphatic diamine and aliphatic diol;
xi) cyclic amide, aminocarboxylic acid, and hydroxycarboxylic acid
xii) cyclic amide and hydroxycarboxylic acid;
xiii) aliphatic polyamide and hydroxycarboxylic acid;
xiv) cyclic amide, cyclic ester, dicarboxylic acid or ester and aliphatic diol;
xv) a triol/diol/aliphatic dicarboxylic acid crosspolymer and a polyamide; and
xvi) triol, diol, aliphatic dicarboxylic acid and a cyclic amide.

45. The method for preparing a compostable and/or degradable polymer composition according to claim 43, wherein polymer (A) is prepared by melting an aliphatic polyamide and blending at least one hydroxycarboxylic acid selected from Formula V:
HO—(CR₂)ₙ—COOH (V)
where n is a whole number ranging from 2 to 6 and R is selected from the group consisting of hydrogen, methyl and ethyl.

46. The method for preparing a compostable and/or degradable polymer composition according to claim 43, wherein polymer (A) is prepared by melting an aliphatic polyamide and either a polyester or cyclic ester together and mixing for greater than one minute in the melt.

47. The method for preparing a compostable and/or degradable polymer composition according to claim 43, wherein the preparation of polymer (A) further comprises adding tin octoate to the melted mixture.

48. The method for preparing a compostable and/or degradable polymer composition according to claim 43, wherein polymer (A) is prepared by combining a cyclic amide, a cyclic ester, and an anionic catalyst.

49. The method for preparing a compostable and/or degradable polymer composition according to claim 48, wherein the cyclic amide ranges from 90 wt % to 20 wt % and the cyclic ester ranges from 10 wt % and 80 wt %.

50. The method for preparing a compostable and/or degradable polymer composition according to claim 48, wherein the anionic catalyst varies between 20-5,000 ppm.

51. The method for preparing a compostable and/or degradable polymer composition according to claim 48, wherein the anionic catalyst is sodium methoxide and/or the sodium salt of caprolactam.

52. The method for preparing a compostable and/or degradable polymer composition according to claim 43, wherein polymer (A) is prepared by combining a cyclic amide, a cyclic ester, and water.

53. The method for preparing a compostable and/or degradable polymer composition according to claim 52, wherein the cyclic amide ranges from 98 wt % to 20 wt % and the cyclic ester ranges from 2 wt % and 80 wt %.

54. The method for preparing a compostable and/or degradable polymer composition according to claim 52, wherein the amount of water ranges from 1-3 wt %.

55. The method for preparing a compostable and/or degradable polymer composition according to claim 43, which includes a crosslinking agent.

56. The method for preparing a compostable and/or degradable polymer composition according to claim 55, wherein the crosslinking agent is selected from the group consisting of a triamine, triol, jeffamine, polyethyleneimine, multifunctional amines, glycerol, sorbitol, EVOH, PVOH, triaminopyrimidines, tetraazacyclotetradecane, tricarboxylic acid or ester, tetracarboxylic 8 acid or ester, methylene bis(4-phenyl isocyanate), vinyltrimethoxysilane, diethylene glycol diglycidyl ether, epichlorohydrin, 1,1,3,3,5,5,7,7,9,9,11,11-dodecamethyl-1,11-bis(4-(oxiranylmethoxy)phenyl)-Hexasiloxane, 3-(trimethoxysilyl)-1-Propanamine, zinc pyrophosphate, zinc oxide and mixtures thereof.

57. The method for preparing a compostable and/or degradable polymer composition according to claim 55, wherein the crosslinking agent is selected from the group consisting of 3,3-dimethoxy-7,9-dimethyl-7-((nonamethyltetrasiloxanyl)oxy))-9-((trimethylsilyl)oxy)-2,8,13-Trioxa-3,7,9-trisilapentadecan-15-ol; 1,1,1,3,3,5,5,7,7,9,11,13,15,17,19,19,19-heptadecamethyl-9,11,13,15,17-pentakis(2-(7-oxabicyclo(4.1.0)hept-3-yl)ethyl)Decasiloxane,; Poly(oxy(1,1,3,3,5,5,7,7-octamethyl-1,7-tetrasiloxanediyl)oxy-1,3-phenylene(phenylimino)(1,1′-biphenyl)-4,4′-diyl(phenylimino)-1,3-phenylene); 1,1,3,3,5,5,7,7-octamethyl-1,7-Tetrasiloxanediol, diacetate; α-(nonamethyltetrasiloxanyl)-γ((trimethylsilyl)oxy)poly(oxy(((diethylamino)oxy)methylsilylene)); dodecamethylpentasiloxane; α-(nonamethyltetrasiloxanyl)-γ-((trimethylsilyl)oxy)poly(oxy(((diethylamino)oxy)methylsilylene)); 1,1,3,3,5,5,7,7,9,9-decamethyl-1,9-pentasiloxanediol; 1,1,3,3,5,5,7,7,9,9-decamethyl-1,9-bis(4-(oxiranylmethoxy)phenyl)-pentasiloxane; 1,1,3,3,5,5,7,7,9,9,11,11-dodecamethyl-1,11-bis(4-(oxiranylmethoxy)phenyl)-hexasiloxane; 1,1,3,3,5,5,7,7,9,9,11,11,13,13,15,15-hexadecamethyl-1,15-bis(4-(oxiranylmethoxy)phenyl)-octasiloxane; 1,1,3,3,5,5,7,7,9,9,11,11,13,13,15,15,17,17-octadecamethyl-1,17-bis(4-(oxiranylmethoxy)phenyl)-nonasiloxane; 1,1;3,3,5,5,7,7,9,9,11,11,13,13,15,15,17,17,19,19,21,21,23,2 3-tetracosamethyl-1,23-bis(4-(oxiranylmethoxy)phenyl)-dodecasiloxane; 4,4′-(1,1,3,3,5,5,7,7,9,9-decamethyl-1,9-pentasiloxanediyl)bis-phenol; 4,4′-(1,1,3,3,5,5,7,7,9,9,11,11-dodecamethyl-1,11-hexasiloxanediyl)bis-phenol; 4,4′-(1,1,3,3,5,5,7,7,9,9,11,11,13,13,15,19-hexadecamethyl-1,15-octasiloxanediyl)bis-phenol; 4,4′-(1,1,3,3,5,5,7,7,9,9,11,11,13,13,15,15,17,17-octadecamethyl-1,17-nonasiloxanediyl)bis-phenol; 4,4′-(1,1,3,3,5,5,7,7,9,9,11,11,13,13,15,15,17,17,19,19,21,21,23, 23-tetracosamethyl-1,23-dodecasiloxanediyl)bis-phenol; 1,1,3,3,5,5,7,7-octamethyl-1,7,-tetrasiloxanediol; 1-ethenyl-1,3,3,5,5,7,7-heptamethyl-1,7-tetrasiloxanediol; 1,1,3,3,5,5-hexamethyl-7,7-diphenyl-1,7-tetrasiloxanediol; 1,1,3,3,5,5,7-heptamethyl-7-(3,3,3-trifluoropropyl)-1,7-tetrasiloxanediol; 1,1,3,3,5,5,7-heptamethyl-7-phenyl-1,7-tetrasiloxanediol; N,N′-(1,1,3,3,5,5,7,7,9,9,11,11-dodecamethyl-1,11-hexasiloxanediyl)di-3,1-propanediyl)bis(N-(oxiranylmethyl)oxiranemethanamine; 1,1,3,3,5,5,7,7,9,9,11,11,13,13,15,15,17,17,19,19-eicosamethyl-1,19-bis(4-(methyl-1-(4-oxiranylmethoxy)phenyl)ethyl)phenoxy)-decasiloxane; and 1,1,3,3,5,5-hexamethyl-1,5-bis(4-(1-methyl-1-(4-(oxiranylmethoxy)phenyl) ethyl)phenoxy)-trisiloxane.

58. The method for preparing a compostable and/or degradable polymer composition according to claim 56, wherein the crosslinking agent is selected from the group consisting of zinc pyrophosphate, zinc oxide and mixtures thereof.

59. The method for preparing a compostable and/or degradable polymer composition according to claim 55, wherein the crosslinking agent is incorporated at a level of 0.0 to 2.0 weight percent.

60. The method for preparing a compostable and/or degradable polymer composition according to claim 43, further comprising component (E) which is a polymer end-capped with functional groups.

61. The method for preparing a compostable and/or degradable polymer composition according to claim 60, wherein component (E) is selected from the group consisting of polyether diol, polysilylalcohol, polyesteramidepolyols, polyurethanepolyols, hydroxylated acrylate resins, polyester diols, aminopropyl-terminated polyethylene glycol, aminopropyl-terminated polypropylene glycol, end-capped methacrylate functionalized polyethyleneglycol and epichlorohydrin derivatized polyethylene glycol.

62. The method for preparing a compostable and/or degradable polymer composition according to claim 61, wherein the polyether diol is selected from the group consisting of polyethylene glycol, polyethylene ether glycol, polypropylene ether glycol, polytetramethylene ether glycol, polyhexamethylene ether glycol.

63. The method for preparing a compostable and/or degradable polymer composition according to claim 62, wherein component (E) has a molecular weight of 600 to 4000 dalton.

64. The method for preparing a compostable and/or degradable polymer composition according to claim 43, wherein polymer (B) is a polylactic acid in a range of 1 to 60 wt % of the total composition.

65. The method for preparing a compostable and/or degradable polymer composition according to claim 43, wherein polymer (B) is a polyhydroxyalkanoate in a range of 1 to 60 wt % of the total composition.

66. The method for preparing a compostable and/or degradable polymer composition according to claim 43, wherein polymer (B) is in a range of 1 to 60 wt % of the total composition and is selected from the group consisting of starch, starch derivative, cellulose, chitin, amylose, amylopectin and mixtures thereof.

67. The method for preparing a compostable and/or degradable polymer composition according to claim 43, wherein polymer (A) is polycaprolactam and polymer (B) is polyvinyl alcohol.

68. The method for preparing a compostable and/or degradable polymer composition according to claim 43, wherein the cyclic amide is caprolactam, the cyclic ester is caprolactone, the dicarboxylic acid or ester is dimethylterephthalate and the aliphatic diol is selected from the group consisting of ethylene glycol and 1,4-butanediol.

69. The method for preparing a compostable and/or degradable polymer composition according to claim 62, wherein caprolactam is 20-90 wt %, caprolactone is 0-40 wt %; dimethylterephthalate is 5-40 wt %, and ethylene glycol is 5--40 wt %.

70. A compostable, degradable film comprising the polymer composition of claim 1.

71. A compostable, degradable injection molded article comprising the polymer composition of claim 1.

72. A degradable monofilament comprising the polymer composition of claim 1.

73. A compostable, degradable fiber comprising the polymer composition of claim 1.

74. A disposable article comprising the polymer composition of claim 1.

75. A compostable, degradable manufactured article comprising the polymer composition of claim 1.

76. A compostable, degradable manufactured article according to claim 75 which is in the form of a sphere having a diameter of between 1 micron -and 50 cm and a skin thickness ranging from 0.01 micron to 2.0 mm.

77. A method for preparing a compostable and/or degradeable sphere comprising forming a film of the compostable and/or degradable polymer composition according to claim 1 across an orifice, applying a blowing fluid at a positive pressure on an inner surface of the film and blowing the film to expand the film through the orifice and applying an external pulsating or fluctuating pressure field having periodic oscillations on an outer surface of the blown film, and detaching the sphere from said orifice.

78. The method according to claim 77, wherein the film of the compostable and/or degradable polymer composition has a viscosity of 0.10 to 600 poises.

79. The method according to claim 77, wherein the film of the compostable and/or degradable polymer composition has a viscosity of 0.5 to 100 poises.

80. The method according to claim 77, wherein the film of the compostable and/or degradable polymer composition has a viscosity of 100 to 400 poises.

81. The method according to claim 77, wherein the blowing fluid is a gas at a pressure of less than 500 p.s.i.g.

82. The method according to claim 77, wherein said blowing fluid is a solution containing an organic compound or salt thereof.

83. The method according to claim 77, wherein the blowing fluid is an organic compound or salt thereof in the melt phase.

84. The method according to claim 83, wherein said blowing fluid is a polymer in the melt phase.

85. The method according to claim 77 wherein said blowing fluid blows said film downwardly through the orifice and outwardly to form an elongated cylinder shaped liquid film which closes at the orifice.

86. The method according to claim 77, wherein said orifice is on a coaxial nozzle having an orifice, an inner nozzle and an outer nozzle and the external pulsating or fluctuating pressure field having periodic oscillations is caused by an entraining fluid, the film is formed across the orifice of the outer nozzle, the blowing gas is conveyed to the inner surface of the film through said inner nozzle, the entraining fluid passes over and around said coaxial nozzle to dynamically induce separation of the sphere from the coaxial nozzle.

87. The method according to claim 77, wherein the film of the compostable and/or degradable polymer composition becomes isotropically oriented during formation of the sphere.

88. The method according to claim 77, wherein the sphere ranges in size from 1.0 micron to 50 cm in diameter.

89. The method according to claim 87, wherein the polymer is oriented isotropically by expanding the film between the glass transition temperature and the melting temperature.

90. A compostable and/or degradable sphere prepared by the method of claim 88.

91. The compostable and/or degradable sphere according to claim 90, wherein the compostable and/or degradable polymer is prepared by combining 3-8 weight % of a polyesteramide consisting of 20-40% ester units and having a melting point of less than 190° C. with 92-97 weight % of undried starch.

92. The compostable and/or degradable sphere according to claim 90, wherein the compostable and/or degradable polymer is prepared by combining 40-70 weight % of a polyesteramide consisting of 2-80% ester units with 30-60 weight % of polyvinylalcohol and/or polyethylenevinyl alcohol, and wherein the sphere has a diameter of 2.0-6.0 cm.

93. A method of strengthening paper comprising coating the paper with the compostable and/or degradable sphere of claim 90.

94. A method of strengthening paper comprising coating the paper with a sphere composed of polyethylene, polypropylene, or polylactic acid.

95. The compostable and/or degradable polymer composition according to claim 1, further comprising at least one of sugar, peanut butter or soybean oil to attract insects.

96. A compostable and/or degradable polymer composition, comprising:
polylactic acid;
polymer (B) which is at least one polymer selected from the group consisting of polyethylenevinyl alcohol, polyvinyl alcohol, polyester, starch, starch derivative, cellulose, polyethylene glycol, chitin, amylose, amylopectin, starch derivatized with ethyleneimine, cellulose derivatized with ethyleneimine, polysaccharides derivatized with ethyleneimine, lignin derivatized with ethyleneimine, farinaceous materials derivatized with ethyleneimine and mixtures thereof;
component (C) which is a plasticizer; and
component (D) which is a crosslinking agent;
wherein the polymer composition comprises 0 to 60 wt % of polymer (B), 0 to 25 wt % of component (C), and 0 to 5 wt % of component (D);
wherein all wt % values are based upon the total weight of the polymer composition; and
with the proviso that the polymer composition must contain at least one of polymer (B) and component (D).
